(19) United States
(12) Patent Application Publication
(10) Pub. No.: US 2024/0053746 A1
(43) Pub. Date: Feb. 15, 2024

(54) DISPLAY SYSTEM, COMMUNICATIONS SYSTEM, DISPLAY CONTROL METHOD, AND PROGRAM

(71) Applicants: Mototsugu MUROI, Kanagawa (JP); Yuuki SAKAMURA, Ibaraki (JP); Hanako BANDO, Kanagawa (JP)

(72) Inventors: Mototsugu MUROI, Kanagawa (JP); Yuuki SAKAMURA, Ibaraki (JP); Hanako BANDO, Kanagawa (JP)

(21) Appl. No.: 18/283,223

(22) PCT Filed: Mar. 18, 2022
(86) PCT No.: PCT/JP2022/012672

§ 371 Date: Sep. 21, 2023

(30) Foreign Application Priority Data
Mar. 22, 2021 (JP) 2021-047517
Mar. 22, 2021 (JP) 2021-047582
Feb. 15, 2022 (JP) 2022-021463

(51) Int. Cl. G05D 1/00; G05D 1/02

(52) U.S. Cl. CPC G05D 1/0061; G05D 1/0044; G05D 1/0038; G05D 1/0221

(57) ABSTRACT

A display system for performing a predetermined operation with respect to a moving body is disclosed. The display system includes an operation reception unit configured to receive a switching operation to switch an operation mode between a manual operation mode and an autonomous movement mode, the manual operation mode being selected for moving the moving body by manual operation and the autonomous movement mode being selected for moving the moving body by autonomous movement; and a display controller configured to display notification information representing accuracy of the autonomous movement.

### TECHNICAL FIELD

The present disclosure relates to a display system, a communication system, a display control method, and a program.

### BACKGROUND ART

Robots are known to be installed in a location such as a factory or a warehouse and be capable of moving autonomously inside the location. Such robots are used, for example, as inspection robots and service robots, and can perform tasks such as inspection of facility in the location on behalf of an operator.

In addition, there is also known a system in which a user at a remote location can manually operate a robot that is capable of moving autonomously within a location according to a state of the robot, a state of the location, the purpose of use, and the like. For example, Patent Document 1 discloses a content in which an unmanned vehicle switches between autonomous driving and remote control by the unmanned vehicle itself, based on a mixing ratio between a driving environment based on ranging data and a communication environment of a remote control device, and presents results to the user.

In addition, Patent Document 2 discloses a content for manually driving or autonomously navigating a robot to a desired destination using a user interface.

### CITATION LIST

### Patent Literature

[PTL 1] Japanese published unexamined patent application No. 2011-150516
[PTL 2] Japanese Translation of PCT International Application Publication No. JP-T-2014-503376

### SUMMARY OF INVENTION

### Technical Problem

However, in the related art methods, it is difficult for the user to determine an appropriate switching operation when a user desires to switch between the autonomous movement and the manual operation of a moving body such as a robot.

In addition, in the related art methods, it is difficult for a user to properly identify a moving state of a moving body, such as a robot, when the user desires to switch between the autonomous movement and the manual operation of the moving body.

### Solution to Problem

According to an aspect of embodiments, a display system for performing a predetermined operation with respect to a moving body is provided. The display system includes an operation reception unit configured to receive a switching operation to switch an

operation mode between a manual operation mode and an autonomous movement mode, the manual operation mode being selected for moving the moving body by manual operation and the autonomous movement mode being selected for moving the moving body by autonomous movement; and

a display controller configured to display notification information representing accuracy of the autonomous movement.

According to another aspect of embodiments, a display system for displaying an image captured by a moving body that moves within a predetermined location is provided. The display system includes

a receiver configured to receive a captured image from the moving body, the captured image capturing the predetermined location; and

a display controller configured to superimpose and display a virtual route image on a moving route of the moving body in the predetermined location represented in the received captured image.

### Advantageous Effect of the Invention

According to the present embodiment of the disclosure, a user is advantageously enabled to easily determine switching between the autonomous movement and the manual operation of the moving body.

According to the present embodiment of the disclosure, a user is advantageously enabled to properly identify a moving state of the moving body.

### BRIEF DESCRIPTION OF DRAWINGS

FIG. 1 is a diagram illustrating an example of an overall configuration of a communication system.

FIG. 2 is a diagram illustrating an example of a schematic configuration of a moving body.

FIG. 3 is a diagram illustrating an example of a hardware configuration of a moving body.

FIG. 4 is a diagram illustrating an example of a hardware configuration of a display device.

FIG. 5 is a diagram illustrating an example of a functional configuration of a communication system.

FIG. 6 is a schematic diagram illustrating an example of a map information management table.

FIG. 7 is a schematic diagram illustrating an example of a destination series management table.

FIG. 8 is a schematic diagram illustrating an example of a route information management table.

FIG. 9 is a sequence diagram illustrating an example of a movement control process of a moving body.

FIG. 10 is a sequence diagram illustrating an example of a process up to a start of movement of a moving body.

FIG. 11A is a diagram illustrating an example of a route input screen.

FIG. 11B is a diagram illustrating an example of a route input screen.

FIG. 12 is a sequence diagram illustrating an example of a switching process between an autonomous movement and a manual operation of a moving body using an operation screen.

FIG. 13 is a diagram illustrating an example of an operation screen.

FIG. 14 is a diagram illustrating an example of an operation screen.

FIG. 15A is a diagram illustrating an example of an operation screen.

FIG. 15B is a diagram illustrating an example of an operation screen.

FIG. 16 is a flowchart illustrating an example of a switching process between an autonomous movement mode and a manual operation mode in a moving body.

FIG. 17 is a flowchart illustrating an example of an autonomous moving process of a moving body.

FIG. 18 is a sequence diagram illustrating an example of a manual operation process of a moving body.

FIG. 19 is a diagram illustrating an example of an operation command input screen.

FIG. 20A is a diagram illustrating a first modification of the operation screen.

FIG. 20B is a diagram illustrating the first modification of the operation screen.

FIG. 21 is a diagram illustrating a second modification of the operation screen.

FIG. 22 is a diagram illustrating a third modification of the operation screen.

FIG. 23 is a diagram illustrating a fourth modification of the operation screen.

FIG. 24 is a diagram illustrating a fifth modification of the operation screen.

FIG. 25 is a diagram illustrating a sixth modification of the operation screen.

FIG. 26 is a diagram illustrating an example of a functional configuration of a communication system according to a first modification of an embodiment.

FIG. 27 is a sequence diagram illustrating an example of an autonomous movement of a moving body and a switching process of a manual operation using an operation screen according to a first modification of the embodiment.

FIG. 28 is a diagram illustrating an example of the overall configuration of a communication system according to a second modification of the embodiment.

FIG. 29 is a diagram illustrating an example of a functional configuration of a communication system according to a second modification of the embodiment.

FIG. 30 is a sequence diagram illustrating an example of processing up to the start of movement of a moving body according to a second modification of the embodiment.

FIG. 31 is a sequence diagram illustrating an example of an autonomous movement of a moving body and a switching process of a manual operation using an operation screen according to a second modification of the embodiment.

FIG. 32 is a diagram illustrating an example of a functional configuration of a communication system.

### DESCRIPTION OF EMBODIMENTS

Hereinafter, embodiments for carrying out the invention will be described with reference to the drawings. In the description of the drawings, the same elements are denoted by the same reference numerals, and overlapping descriptions are omitted.

### EMBODIMENTS

System Configuration

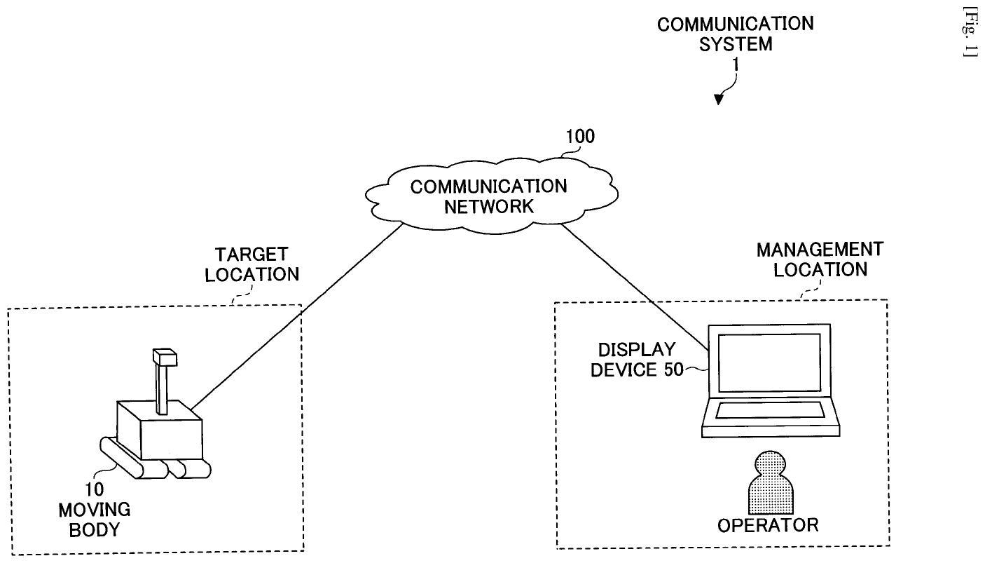

FIG. 1 is a diagram illustrating an example of an overall configuration of a communication system. A communication system 1 illustrated in FIG. 1 is a system that enables a user to remotely control a moving body 10 within a predetermined location.

The communication system 1 includes a moving body 10 disposed in a predetermined location and a display device 50. The moving body 10 and the display device 50 constituting the communication system 1 can communicate through a communication network 100. The communication network 100 is constructed by the Internet, a moving body communication network, a local area network (LAN), or the like. Note that the communication network 100 may include wireless communication networks, such as 3G (3rd Generation), 4G (4th Generation), 5G (5th Generation), Wi-Fi (Wireless Fidelity), WiMAX (Worldwide Interoperability for Microwave Access), and LTE (Long Term Evolution), as well as wired communication networks.

The moving body 10 is a robot installed in a target location and capable of moving autonomously within the target location.

This autonomous movement of the moving body involves simulation learning (machine learning) of previously moved routes within the target location, so as to move autonomously within the target location using results of the simulation learning. The autonomous movement may also involve an operation to move autonomously within the target location according to a predetermined moving route or an operation to move autonomously within the target location using a technique such as line tracing. In addition, the moving body 10 may be moved by manual operation from a remote user. That is, the moving body 10 can move within the target location while switching between an autonomous movement and a manual operation by the user. The moving body 10 may also perform predetermined tasks, such as inspection, maintenance, transport or light duty, while moving within the target location, for example. Herein, the moving body 10 means a robot in a broad sense, and may mean a robot capable of performing both autonomous movement and movement remotely operated by a user. An example of the moving body 10 may include a vehicle which is capable of switching between automatic and manual operations by remote operation. In addition, examples of the moving body 10 may also include aircraft, such as a drone, mul-ticopter, unmanned aerial vehicle, and the like.

The target locations where the moving body 10 is installed include, for example, outdoor locations such as business sites, factories, construction sites, substations, farms, fields, orchard/plantation, arable land, or disaster sites, or indoor locations such as offices, schools, factories, warehouses, commercial facilities, hospitals, or nursing homes. In other words, the target location may be any location where there is a need for a moving body 10 to perform a task that has typically been done manually.

The display device 50 is a computer, such as a laptop PC (Personal Computer) or the like, which is located at a management location different from the target location, and is used by an operator (user) who performs predetermined operations with respect to the moving body 10. At a management location such as an office, the operator uses an operation screen displayed on the display device 50 to perform operations such as moving operations with respect to the moving body 10 or operations for causing the moving body 10 to execute a predetermined task.

For example, the operator remotely controls the moving body 10 while viewing an image of the target location displayed on the display device 50.

FIG. 1 illustrates an example in which a single moving body 10 and a display device 50 are connected to each other through a communication network 100. However, the display device 50 may be configured to connect to a plurality of moving bodies 10 located at a single target location or may be configured to connect to moving bodies 10 located at different target locations. FIG. 1 also illustrates an example in which the display device 50 is located at a remote management location that is different from a target location where the moving body 10 is installed, but the display device 50 may be configured to be located within a target location where the moving body 10 is installed. Additionally, the display device 50 is not limited to a notebook PC, and may be, for example, a desktop PC, a tablet terminal, a smartphone, a wearable terminal, or the like.

In the related art, for example, when a moving body becomes unable to travel due to an obstacle during autonomous movement, the operator manually performs a restoration operation to resume autonomous movement. However, it has been difficult for an operator to make an accurate determination to switch from manual operation to autonomous movement based on the information presented to the operator alone. In addition, when making the moving body to perform autonomous movement through learning during manual operation, but the previous learning results could not be used properly due to changes in the environment, such as weather conditions or buildings within a location, it has been difficult for an operator to make a determination to switch to manual operation for learning again. That is, when an operator wishes to switch between an autonomous movement and a manual operation of a moving body, it is difficult for the operator to use the conventional method to make an appropriate switching determination.

Accordingly, the communication system 1 displays notification information representing the accuracy of the autonomous movement of the moving body 10 on the display device 50, which is used by an operator who remotely operates the moving body 10, such that the communication system 1 enables the operator to easily determine whether to switch between the autonomous movement and the manual operation. In addition, the communication system 1 can mutually switch between the autonomous movement and the manual operation of the moving body 10 using the operation screen displayed on the display device 50, which can improve the user's operability when switching between the autonomous movement and the manual operation of the moving body 10. Further, the communication system 1 can enable the operator to appropriately determine the necessity of learning by manual operation even for the moving body 10 which performs learning of a moving route of the autonomous movement using the manual operation.

Configuration of Moving Body

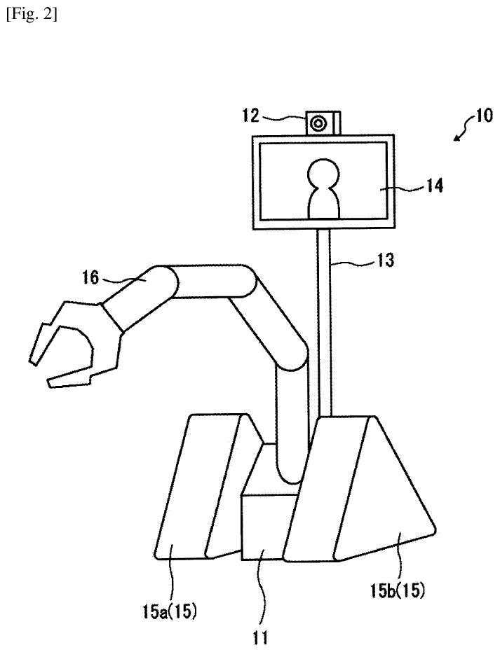

Subsequently, a specific configuration of the moving body 10 will be described with reference to FIG. 2. FIG. 2 is a diagram illustrating an example of a schematic configuration of a moving body. It should be noted that additions or omissions of components in the configuration of the moving body 10 illustrated in FIG. 2 made be made as needed.

The moving body 10 illustrated in FIG. 2 includes a housing 11 that includes a control device 30 configured to control a process or an operation of the moving body 10, an imaging device 12, a support member 13, a display 14, a moving mechanism 15 (15a, and 15b) configured to move the moving body 10, and a movable arm 16 configured to cause the moving body 10 to perform predetermined tasks (operations). The housing 11 includes a control device 30 disposed in the body part of the moving body 10, and configured to control a process or an operation of the moving body 10.

The imaging device 12 captures and acquires a captured image of a subject, such as a person, an object, or a landscape located at a location where the moving body 10 is installed.

The imaging device 12 acquires captured images by capturing subjects such as people, objects, or landscapes at a location where the moving body 10 is installed. The imaging device 12 is a digital camera (general imaging device) capable of acquiring planar images (detailed images), such as a digital single-lens reflex camera or a compact digital camera. The captured image acquired by the imaging device 12 may be a video or a still image, and may be both a video and a still image. The captured image acquired by the captured image imaging device 12 may also include audio data along with image data. In addition, the imaging device 12 may be a wide-angle imaging device capable of acquiring a panoramic image of an entire sphere (360 degrees). A wide-angle imaging device is, for example, an omnidirectional imaging device configured to capture an object and obtain two hemispherical images that are the basis of a panoramic image. Further, the wide-angle imaging device may be, for example, a wide-angle camera or a stereo camera capable of acquiring a wide-angle image having a field angle of not less than a predetermined value. That is, the wide-angle imaging device is a unit configured to capture an image (an omnidirectional image or a wide-angle image) using a lens having a focal length shorter than a predetermined value.

The moving body 10 may also include a plurality of imaging devices 12. In this case, the moving body 10 may be configured to include both a wide-angle imaging device as the imaging device 12 and a general imaging device by which a portion of a subject captured by the wide-angle imaging device can be captured to obtain a detailed image (a planar image). In this case, the moving body 10 may be configured to include, as the imaging device 12, both a wide-angle imaging device and a general imaging device capable of capturing a part of the subject captured by the wide-angle imaging device to obtain a detailed image (planar image).

The support member 13 is a member configured to secure (fixing) the imaging device 12 to the moving body 10 (the housing 11). The support member 13 may be a pole secured to the housing 11 or a pedestal secured to the housing 11. The support member 13 may be a movable member capable of adjusting an imaging direction (orientation) and a position (height) of the imaging device 12.

The moving mechanism 15 is a unit configured to move the moving body 10 and includes wheels, a running motor, a running encoder, a steering motor, a steering encoder, and the like. With regard to the movement control of the moving body 10, the detailed description thereof is omitted because the movement control is a conventional technique. However, the moving body 10 receives a traveling instruction from an operator (the display device 50), for example, and the moving mechanism 15 moves the moving body 10 based on the received traveling instruction. The moving mechanism 15 may be a bipedal walking foot type or a single wheel type. The shape of the moving body 10 is not limited to a vehicle type as illustrated in FIG. 2, and may be, for example, a bipedal walking humanoid type, a simulation form of an organism, a simulation form of a particular character, or the like.

The movable arm 16 has an operating unit that enables additional movement other than movement of the moving body 10. As illustrated in FIG. 2, the movable arm 16 includes, for example, a hand for grasping an object, such as a component, at the end of the movable arm 16 as an operating unit. The moving body 10 can perform predetermined operations (operations) by rotating or deforming the movable arm 16. In addition to the above-described configuration, the moving body 10 may include various sensors capable of detecting information around the moving body 10. The various sensors are sensor devices such as barometers, thermometers, photometers, human sensors, gas sensors, odor sensors, or illuminance meters, for example.

Hardware Configuration

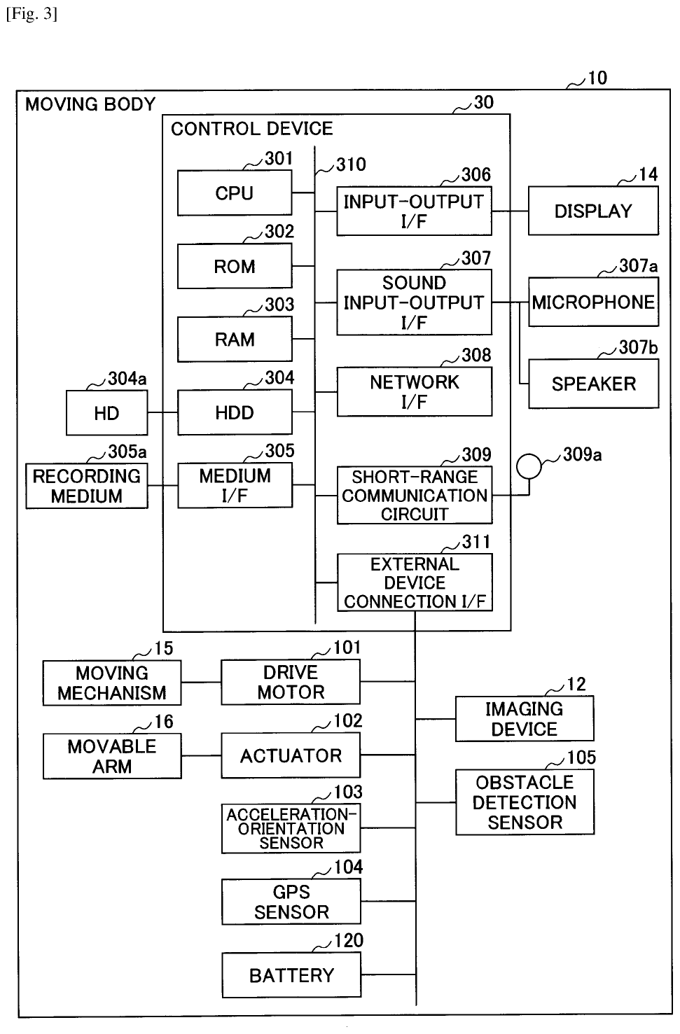

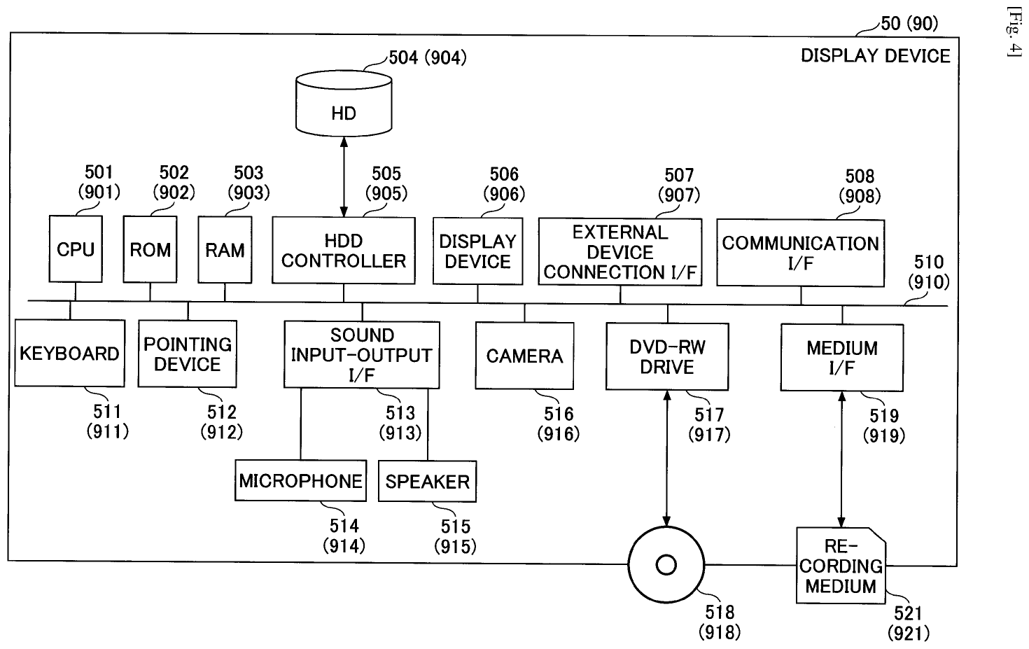

Subsequently, a hardware configuration of a device or a terminal forming a communication system according to an embodiment will be described with reference to FIGS. 3 and 4. It should be noted that additions or omissions of components in the configuration of the device or the terminal illustrated in FIGS. 3 and 4 made be made as needed.

Hardware Configuration of Moving Body

FIG. 3 is a diagram illustrating an example of a hardware configuration of a moving body. The moving body 10 includes a control device 30 configured to control a process or an operation of the moving body 10. The control device 30 is disposed inside a housing 11 of the moving body 10 as described above. The control device 30 may be disposed outside the housing 11 of the moving body 10 or may be provided as a device separate from the moving body 10.

The control device 30 includes a CPU (Central Processing Unit) 301, a ROM (Read Only Memory) 302, a RAM (Random Access Memory) 303, an HDD (Hard Disk Drive) 304, a medium I/F (Interface) 305, an input-output I/F 306, a sound input-output I/F 307, a network I/F 308, a short-range communication circuit 309, an antenna 309a of the short-range communication circuit 309, an external device connection I/F 311, and a bus line 310.

The CPU 301 controls the entire moving body 10. The CPU 301 is an arithmetic-logic device which implements functions of the moving body 10 by loading programs or data stored in the ROM 302, the HD (hard disk) 304a, or the like on the RAM 303 and executing the process.

The ROM 302 is a non-volatile memory that can hold programs or data even when the power is turned off. The RAM 303 is a volatile memory used as a work area of the CPU 301 or the like. The HDD 304 controls the reading or writing of various data with respect to the HD 304a according to the control of the CPU 301. The HD 304a stores various data such as a program. The medium I/F 305 controls the reading or writing (storage) of data with respect to the recording medium 305a, such as a USB (Universal Serial Bus) memory, a memory card, an optical disk, or a flash memory.

The input-output I/F 306 is an interface for inputting and outputting characters, numbers, various instructions, and the like from and to various external devices. The input-output I/F 306 controls the display of various information such as cursors, menus, windows, characters, or images with respect to a display 14 such as an LCD (Liquid Crystal Display). The display 14 may be a touch panel display with an input unit. In addition to the display 14, the input-output I/F 306 may be connected with a pointing device such as a mouse, an input unit such as a keyboard, or the like. The sound input-output I/F 307 is a circuit that processes an input and an output of sound signals between a microphone 307a and a speaker 307b according to the control of the CPU 301. The microphone 307a is a type of a built-in sound collecting unit that receives sound signals according to the control of the CPU 301. The speaker 307b is a type of a playback unit that outputs a sound signal according to the control of the CPU 301.

The network I/F 308 is a communication interface that communicates (connects) with other apparatuses or devices via the communication network 100. The network I/F 308 is, for example, a communication interface such as a wired or wireless LAN. The short-range communication circuit 309 is a communication circuit such as a Near Field Communication (NFC) or Bluetooth™. The external device connection I/F 311 is an interface for connecting other devices to the control device 30.

The bus line 310 is an address bus, data bus, or the like for electrically connecting the components and transmits address signals, data signals, various control signals, or the like. The CPU 301, the ROM 302, the RAM 303, the HDD 304, the medium I/F 305, the input-output I/F 306, the sound input-output I/F 307, the network I/F 308, the short-range communication circuit 309, and the external device connection I/F 311 are interconnected via the bus line 310.

A drive motor 101, an actuator 102, an acceleration-orientation sensor 103, a GPS (Global Positioning System) sensor 104, the imaging device 12, a battery 120, and an obstacle detection sensor 105 are connected to the control device 30 via an external device connection I/F 311.

The drive motor 101 rotates the moving mechanism 15 to move the moving body 10 along the ground in accordance with an instruction from the CPU 301. Actuator 102 deforms movable arm 16 based on instructions from CPU 301. The acceleration-orientation sensor 103 is a sensor such as an electromagnetic compass, a gyrocompass, and an acceleration sensor for detecting geomagnetic fields. A GPS sensor 104 receives a GPS signal from a GPS satellite. A battery 120 is a unit that supplies the necessary power to the entire moving body 10. The battery 120 may include an external battery that serves as an external auxiliary power supply, in addition to the battery 120 contained within the moving body 10. An obstacle detection sensor 105 is a sensing sensor that detects surrounding obstacles as the moving body 10 moves. The obstacle detection sensor 105 is, for example, an image sensor such as a stereo camera or a camera mounted on an area sensor having a photoelectric conversion element arranged in a plane, or a ranging sensor such as a TOF (Time of Flight) sensor, a Light Detection and Ranging (LIDAR) sensor, a radar sensor, a laser rangefinder, an ultrasonic sensor, a depth camera, or a depth sensor.

### Hardware Configuration of Display

FIG. 4 is a diagram illustrating an example of a hardware configuration of a display device. Each hardware configuration of the display device 50 is indicated by a numeral 500. The display device 50 is constructed by a computer and includes a CPU 501, a ROM 502, a RAM 503, an HD 504, an HDD controller 505, a display device 506, an external device connection I/F 507, a network I/F 508, a bus line 510, a keyboard 511, a pointing device 512, a sound input-output I/F 513, a microphone 514, a speaker 515, a camera 516, a DVD-RW (Digital Versatile Disk Rewritable) drive 517, and a medium I/F 519, as illustrated in FIG. 4.

Of these, the CPU 501 controls the operation of the entire display device 50. The ROM 502 stores a program used to drive the CPU 501, such as IPL (Initial Program Loader). The RAM 503 is used as the work area of the CPU 501. The HD 504 stores various data such as a program. The HDD controller 505 controls the reading or writing of various data with respect to the HD 504 according to the control of the CPU 501. The display device 506 displays various information such as cursors, menus, windows, characters, or images. The display device 506 may be a touch panel display with an input unit. The display device 506 is an example of a display unit. The display unit as the display device 506 may be an external device having a display function connected to the display device 50. The display unit may be, for example, an external display, such as an IWB (Interactive White Board), or a projected portion (e.g., a ceiling or wall of a management location, a windshield of a vehicle body, etc.) on which images are projected from a PJ (Projector) or a HUD (Head-Up Display) connected as an external device. The external device connection I/F 507 is an interface for connecting various external devices. The network I/F 508 is an interface for performing data communication using the communication network 100. The bus line 510 is an address bus or data bus or the like for electrically connecting components such as the CPU 501 illustrated in FIG. 4.

The keyboard 511 is a type of input unit having a plurality of keys for inputting characters, numbers, various instructions, and the like. The pointing device 512 is a type of input unit for selecting or executing various instructions, selecting a process target, moving a cursor, and the like. The input unit may be not only a keyboard 511 and a pointing device 512, but also a touch panel or a voice input device. The input unit, such as a keyboard 511 and a pointing device 512, may also be a UI (User Interface) external to the display device 50. The sound input-output I/F 513 is a circuit that processes sound signals between a microphone 514 and a speaker 515 according to the control of CPU 501. The microphone 514 is a type of built-in sound collecting unit for inputting voice. The speaker 515 is a type of built-in output unit for outputting an audio signal. The camera 516 is a type of built-in imaging unit that captures a subject to obtain image data. The microphone 514, the speaker 515, and the camera 516 may be an external device instead of being built into the display device 50. The DVD-RW drive 517 controls the reading or writing of various data with respect to the DVD-RW 518 as an example of a removable recording medium. The removable recording medium is not be limited to a DVD-RW, and may be a DVD-R or a Blu-ray disc (Blu-ray disc). The medium I/F 519 controls the reading or writing (storage) of data with respect to the recording medium 521, such as a flash memory.

Each of the above-described programs may be distributed by recording a file in an in-stallable format or an executable format in a computer-readable recording medium. Examples of the recording medium include a CD-R (Compact Disc Recordable), a DVD (Digital Versatile Disk), a Blu-ray Disc, an SD card or a USB memory, and the like. The recording medium may also be provided as a program product domestically or internationally. For example, the display device 50 implements a display control method according to the present invention by executing a program according to the present invention.

Functional Configuration

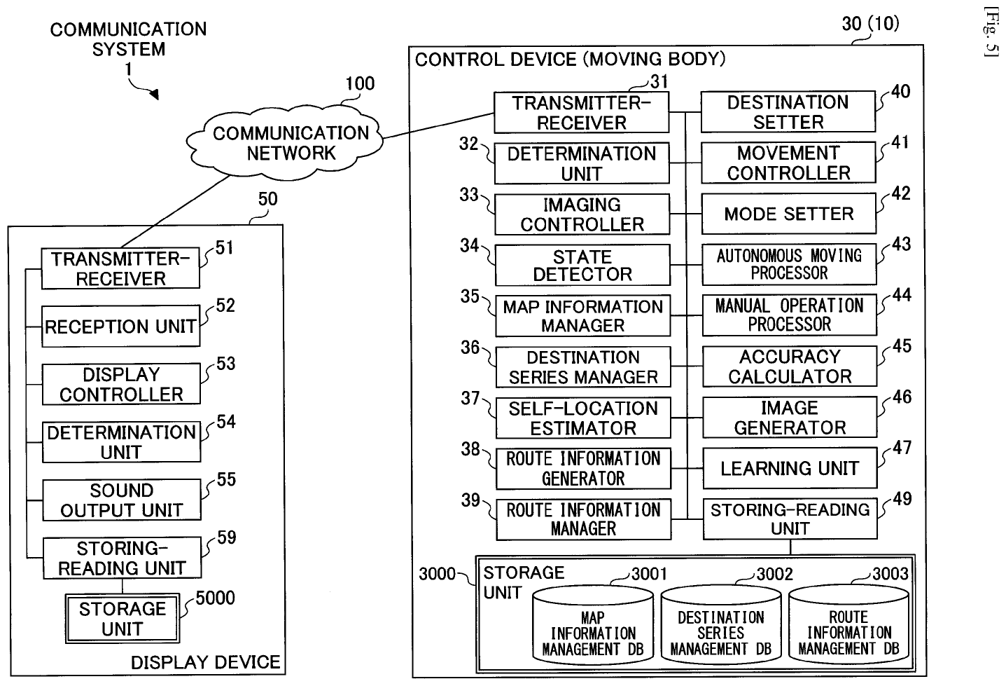

Next, a functional configuration of the communication system according to the embodiment will be described with reference to FIGS. 5 to 8. FIG. 5 is a diagram illustrating an example of a functional configuration of a communication system. FIG. 5 illustrates a device or a terminal illustrated in FIG. 1 that is associated with a process or an operation described later.

Function Configuration of Moving Body (Control Device)

First, a functional configuration of the control device 30 configured to control the process or operation of the moving body 10 will be described with reference to FIG. 5. The control device 30 includes a transmitter-receiver 31, a determination unit 32, an imaging controller 33, a state detector 34, a map information manager 35, a destination series manager 36, a self-location estimator 37, a route information generator 38, a route information manager 39, a destination setter 40, a movement controller 41, a mode setter 42, an autonomous moving processor 43, a manual operation processor 44, an accuracy calculator 45, an image generator 46, a learning unit 47, and a storing-reading unit 49. Each of these units is a function or a functional unit implemented by operating one of the components illustrated in FIG. 3 according to an instruction from the CPU 301 by following a program for the control device loaded on the RAM 303. The control device 30 includes a storage unit 3000 that is constructed by the ROM 302, the HD 304a, or the recording medium 305a illustrated in FIG. 3.

The transmitter-receiver 31 is mainly implemented by a process of the CPU 301 with respect to the network I/F 308, and transmits and receives various data or information from and to other devices or terminals through the communication network 100.

The determination unit 32 is implemented by a process of the CPU 301 and performs various determinations. The imaging controller 33 is implemented mainly by a process of the CPU 301 with respect to the external device connection OF 311, and controls the imaging process to the imaging device 12. For example, the imaging controller 33 instructs the imaging process to be performed on the imaging device 12. The imaging controller 33 acquires, for example, the captured image obtained through the imaging process by the imaging device 12.

The state detector 34 is implemented mainly by a process of the CPU 301 with respect to the external device connection OF 311, and detects the moving body 10 or the state around the moving body 10 using various sensors. The state detector 34 measures a distance to an object (an obstacle) that is present around the moving body 10 using, for example, an obstacle detection sensor 105 and outputs the measured distance as distance data.

The state detector 34 detects a position of the moving body 10 using, for example, a GPS sensor 104. Specifically, the state detector 34 acquires the position stored in an environmental map stored in the map information management DB 3001 using a GPS sensor 104 or the like. The state detector 34 may be configured to apply SLAM (Simultaneous Localization and Mapping) using distance data measured using an obstacle detection sensor 105 or the like to acquire a position by matching with the environmental map. Here, SLAM is a technology capable of simultaneously performing self-location estimation and environmental mapping.

Further, the state detector 34 detects the direction in which the moving body 10 is facing using, for example, an acceleration-orientation sensor 103.

The map information manager 35 is mainly implemented by a process of the CPU 301, and manages map information representing an environmental map of a target location in which the moving body 10 is installed using the map information management DB 3001. For example, the map information manager 35 manages the environmental map downloaded from an external server or the like or the map information representing the environmental map created by applying SLAM.

The destination series manager 36 is mainly implemented by a process of the CPU 301, and manages the destination series on a moving route of the moving body 10 using the destination series management DB 3002. The destination series includes a final destination (goal) on the moving route of the moving body 10 and multiple waypoints (sub-goals) to the final destination. The destination series is data specified by location information representing a position (coordinate values) on the map, such as latitude and longitude, for example. The destination series may be obtained, for example, by remotely manipulating and designating the moving body 10. The des-ignation method may be specified, for example, by GUI (Graphical User Interface) from the environmental map.

The self-location estimator 37 is mainly implemented by a process of the CPU 301 and estimates the current position (self-location) of the moving body 10 based on the location information detected by the state detector 34 and the direction information indicating the direction in which the moving body 10 is facing. For example, the self-location estimator 37 uses a method such as an extended Kalman filter (EKF) for es-timating the current position (self-location).

The route information generator 38 is implemented mainly by a process of the CPU 301 and generates the route information representing the moving route of the moving body 10. The route information generator 38 sets a final destination (goal) and a plurality of waypoints (sub-goals) using a current position (self-location) of the moving body 10 estimated by the self-location estimator 37 and the destination series managed by the destination series manager 36, and generates route information representing the route from the current position to the final destination. For example, a method of generating route information is used such that each waypoint from the current position to the final destination is connected by a straight line, or a method of minimizing a moving time while avoiding obstacles by using the captured image or obstacle information obtained by the state detector 34 is used.

The route information manager 39 is mainly implemented by a process of the CPU 301 and manages the route information generated by the route information generator 38 using the route information management DB 3003.

The destination setter 40 is implemented mainly by a process of the CPU 301 and sets a moving destination of the moving body 10. For example, based on the current position (self-location) of the moving body 10 estimated by the self-location estimator 37, the destination setter 40 sets a destination (a current goal) or a waypoint (a sub-goal) to which the moving body 10 should be currently directed to from among the destination series managed by the destination series manager 36 as the moving destination. An example of a method of setting the moving destination includes, for example, a method of setting a destination series that is closest to the current position (self-location) of the moving body 10 among series of destinations at which” the moving body 10 has yet to arrive (e.g., the status is “unarrived”), or a method of setting a destination series with the smallest data index among series of destinations at which” the moving body 10 has yet to arrive.

The movement controller 41 is implemented mainly by a process of the CPU 301 with respect to the external device connection I/F 311, and controls the movement of the moving body 10 by driving the moving mechanism 15. The movement controller 41 moves the moving body 10 in response to a drive instruction from the autonomous moving processor 43 or the manual operation processor 44, for example.

The mode setter 42 is implemented mainly by a process of the CPU 301 and sets an operation mode representing an operation of moving the moving body 10. The mode setter 42 sets either an autonomous movement mode in which the moving body 10 is moved autonomously or a manual operation mode in which the moving body 10 is moved by manual operation of an operator. The mode setter 42 switches the setting between the autonomous movement mode and the manual operation mode in accordance with a switching request transmitted from the display device 50, for example.

The autonomous moving processor 43 is mainly implemented by a process of the CPU 301 and controls an autonomous moving process of the moving body 10. The autonomous moving processor 43 outputs, for example, a driving instruction of the moving body 10 to the movement controller 41 so as to pass the moving route illustrated in the route information generated by the route information generator 38.

The manual operation processor 44 is implemented mainly by a process of the CPU 301 and controls a manual operation process of the moving body 10. The manual operation processor 44 outputs a drive instruction of the moving body 10 to the movement controller 41 in response to the manual operation command transmitted from the display device 50.

The accuracy calculator 45 is implemented mainly by a process of the CPU 301 and calculates accuracy of the autonomous movement of the moving body 10. Herein, the accuracy of the autonomous movement of the moving body 10 is information indicating the certainly degree (confidence degree) as to whether or not the moving body 10 is capable of moving autonomously. The higher the value to be calculated, the more likely the moving body 10 is capable of moving autonomously. The accuracy of autonomous movement may be calculated by, for example, lowering the value when the likelihood decreases based on the numerical value of the likelihood of self-location estimated by the self-location estimator 37, lowering the value when the variance increases using the variance of various sensors, etc., lowering the value when the moving time of the autonomous movement mode increases by using the movement elapsed time which is the operating state of the autonomous moving processor 43, lowering the value when the distance increases according to the distance between the destination series and the moving body 10, or lowering the value when there are many obstacles according to the information on obstacles detected by the state detector 34.

The image generator 46 is mainly implemented by a process of the CPU 301 and generates a display image to be displayed on the display device 50. The image generator 46 generates, for example, a route image representing a destination series managed by the destination series manager 36 on the captured image captured by the imaging controller 33. The image generator 46 renders the generated route image on the moving route of the moving body 10 with respect to the captured image data acquired by the imaging controller 33. An example of a method of rendering a route image on the captured image data includes a method of performing perspective projection conversion to render a route image, based on the self-location (current position) of the moving body 10 estimated by the self-location estimator 37, the in-stallation position of the imaging device 12, and the angle of view of the captured image data. Note that the captured image data may include parameters of a PTZ (Pan-Tilt-Zoom) for specifying the imaging direction of the imaging device 12 or the like. The captured image data including parameters of the PTZ is stored (saved) in the storage unit 3000 of the moving body 10. The parameters of the PTZ may be stored in the storage unit 3000 in association with the destination candidate, that is, the location information of the final destination (goal) formed by the destination series and the plurality of waypoints (sub-goals) to the final destination. The coordinate data (x, y, and θ) representing the position of the moving body 10 when the captured image data of the destination candidate is acquired may be simultaneously stored with the location information of the destination candidate in the storage unit 3000. This enables the orientation of the moving body 10 to be corrected using the PTZ parameters and the co-ordinate data (x, y, θ) when the actual stop position of the moving body 10 relative to the destination is shifted. Note that some data, such as the data of the autonomous moving route (GPS trajectory) of the moving body 10 and the captured image data of the destination candidate used for display on the display device 50, may be stored in cloud computing services such as, for example, AWS (Amazon Web Services (trademark).

The image generator 46 renders, for example, the current position (self-location) of the moving body 10 estimated by the self-location estimator 37 and the destination series managed by the destination series manager 36 on an environmental map managed by the map information manager 35. Examples of a method of rendering on an environmental map include, for example, a method of using location information such as latitude and longitude of GPS or the like, a method of using coordinate information obtained by SLAM, and the like.

The learning unit 47 is implemented mainly by a process of the CPU 301 and learns the moving route for performing autonomous movement of the moving body 10. The learning unit 47, for example, performs simulation learning (machine learning) of the moving route associated with autonomous movement, based on the captured image acquired during the movement in the manual operation mode by the manual operation processor 44 and the detected data by the state detector 34. The autonomous moving processor 43 performs autonomous movement of the moving body 10 based on learned data, for example, which is the result of simulation learned by the learning unit 47.

The storing-reading unit 49 is mainly implemented by a process of the CPU 301 and stores various data (or information) in the storage unit 3000 or reads various data (or information) from the storage unit 3000.

Map Information Management Table

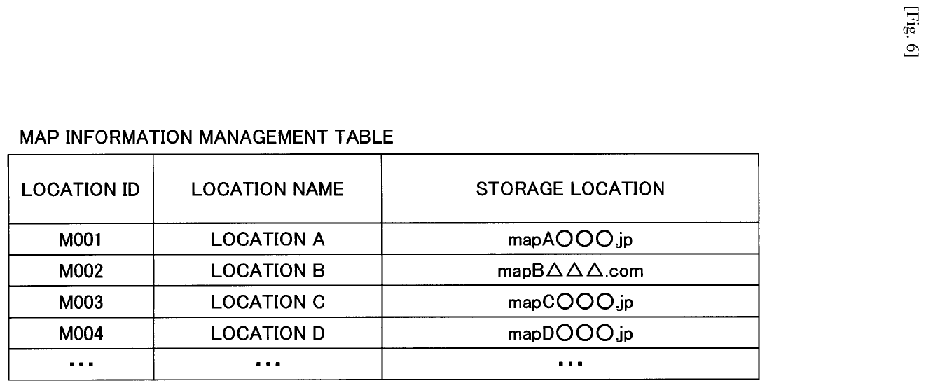

FIG. 6 is a schematic diagram illustrating an example of a map information management table. The map information management table is a table for managing map information that is an environmental map of a target location where the moving body 10 is installed. A map information management DB 3001 configured with a map information management table illustrated in FIG. 6 is constructed in the storage unit 3000.

The map information management table manages a location ID and a location name for identifying a target location where the moving body 10 is installed, as well as map information associated with a storage location of an environmental map of the target location. The storage location is, for example, a storage area storing an environmental map within the moving body 10 or destination information for accessing an external server indicated by a URL (Uniform Resource Locator) or a URI (Uniform Resource Identifier).

Destination Series Management Table

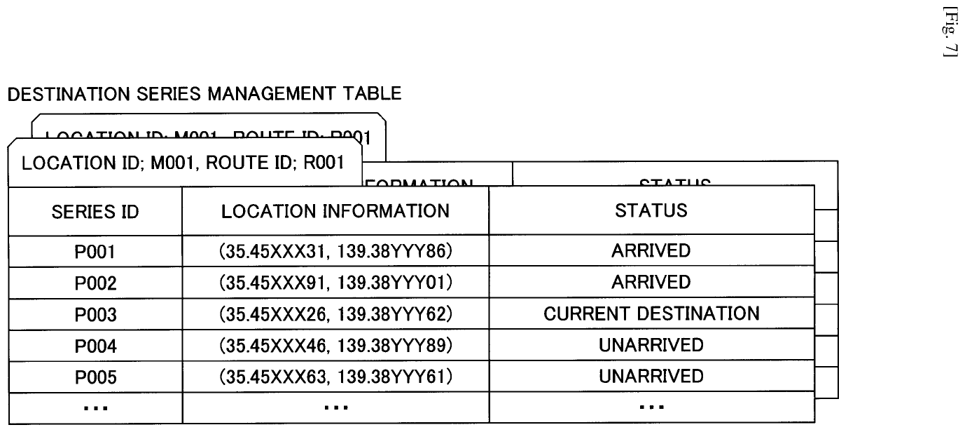

FIG. 7 is a schematic diagram illustrating an example of a destination series management table. The destination series management table is a table for managing a destination series that contains a final destination or a plurality of waypoints on the moving route of the moving body 10 for identifying the moving route. A destination series management DB 3002 configured with a destination series management table illustrated in FIG. 7 is constructed in the storage unit 3000.

The destination series management table manages the series ID for identifying the destination series, location information for indicating the position of the destination series on the environmental map, and status information for indicating a moving state of the moving body 10 relative to the destination series in association with each location ID for identifying the location where the moving body 10 is installed and each route ID for identifying the moving route of the moving body 10. Of these, the location information is represented by latitude and longitude coordinate information indicating the position of the moving body 10 in the destination series on the environmental map. In addition, the status indicates whether or not the moving body 10 has arrived at the destination series. The status includes, for example, “arrived,” “current destination,” and “unarrived” The status is updated according to the current position and the moving state of the moving body 10.

### Route Information Management Table

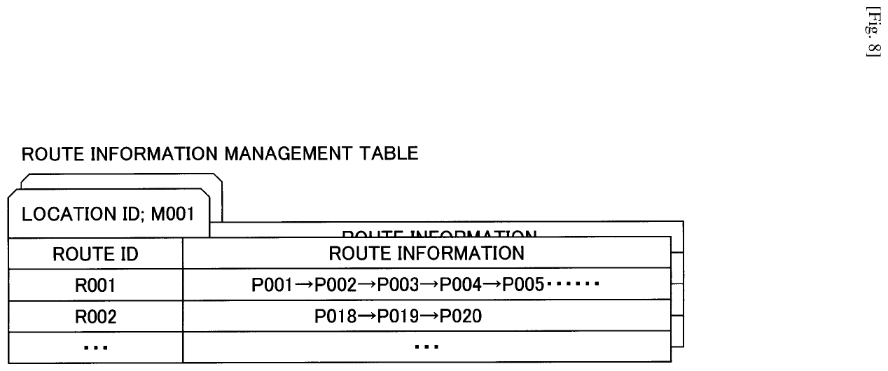

FIG. 8 is a schematic diagram illustrating an example of a route information management table. The route information management table is a table for managing route information representing the moving route of the moving body 10. The route information management DB 3003 configured with the route information management table illustrated in FIG. 8 is constructed in the storage unit 3000.

The route information management table manages the route ID for identifying the moving route of the moving body 10 and the route information for indicating the moving route of the moving body 10 for each location ID for identifying the location where the moving body 10 is installed. Of these, the route information illustrates the future route of the moving body 10 in the order of the destination series as the destination in the future. The route information is generated when the moving body 10 starts moving by the route information generator 38.

Functional Configuration of Display Device

Next, a functional configuration of the display device 50 will be described with reference to FIG. 5. The display device 50 includes a transmitter-receiver 51, a reception unit 52, a display controller 53, a determination unit 54, a sound output unit 55, and a storing-reading unit 59. Each of these units is a function or a functional unit implemented by operating one of the components illustrated in FIG. 4 according to an instruction from the CPU 501 by following a program for a display device loaded on the RAM 503. The display device 50 includes a storage unit 5000 that is constructed by the ROM 502, the HD 504, or the recording medium 521 illustrated in FIG. 4.

The transmitter-receiver 51 is implemented mainly by a process of the CPU 501 with respect to the network I/F 508, and transmits and receives various data or information from and to other devices or terminals.

The reception unit 52 is implemented mainly by a process of the CPU 501 with respect to the keyboard 511 or the pointing device 512 to receive various selections or inputs from a user. The display controller 53 is implemented mainly by a process of the CPU 501 and displays various screens on a display unit such as the display device 506. The determination unit 54 is implemented by a process of the CPU 501 and performs various determinations. The sound output unit 55 is implemented mainly by a process of the CPU 501 with respect to the sound input-output I/F 513 and outputs an audio signal, such as a warning sound, from the speaker 515 according to the state of the moving body 10.

The storing-reading unit 59 is mainly implemented by a process of the CPU 501, and stores various data (or information) in the storage unit 5000 or reads various data (or information) from the storage unit 5000.

Process or Operation of Embodiments

Movement Control Process

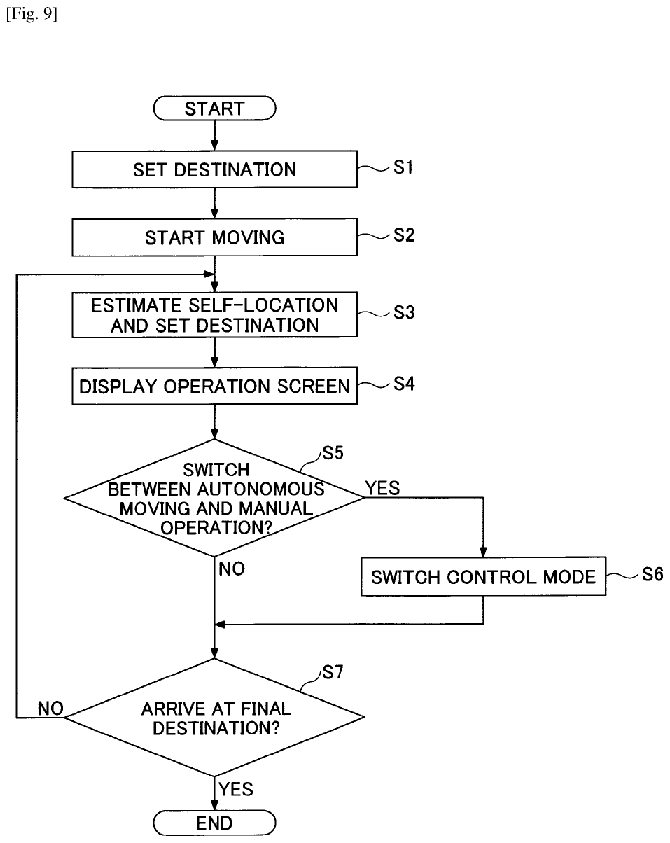

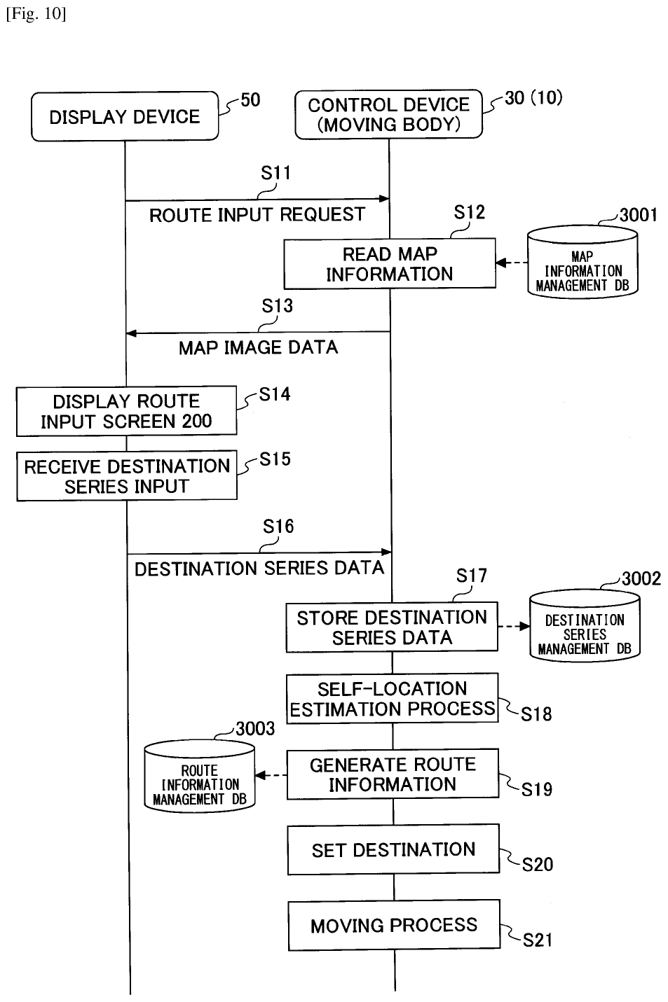

Next, a process or operation of the communication system according to the embodiment will be described with reference to FIGS. 9 to 21. First, an overall flowchart of the movement operation of the moving body 10 will be described schematically with reference to FIG. 9. FIG. 9 is a sequence diagram illustrating an example of a movement control process of a moving body. The details of each process illustrated in FIG. 9 will be described with reference to FIGS. 10 to 19, which will be described later.

First, in step S1, the destination setter 40 sets a current destination to which the moving body 10 is to be moved as a moving destination of the moving body 10. In this case, the destination setter 40 sets the destination based on the position and status of the destination series stored in the destination series management DB 3002 (see FIG. 7). In step S2, the moving body 10 starts to move according to the moving route illustrated in the route information generated by the route information generator 38 with respect to the destination set in step S1. In step S3, while the moving body 10 moves according to the moving route set in step S1, the self-location estimator 37 performs self-location estimation and sets a moving destination that is a closest destination to the final destination until the moving body 10 arrives at the final destination set by the destination setter 40.

Next, in step S4, the display device 50 displays an operation screen for operating the moving body 10 on a display unit, such as a display device 506, based on various data or information transmitted from the moving body 10 while the moving body 10 is moving within a target location. When the moving body 10 performs switching between an autonomous movement and a manual operation based on a request from the display device 50 (YES in step S5), the process proceeds to step S6. By contrast, when the switching is not performed between the autonomous movement and the manual operation (NO in step S5), the process proceeds to step S7. In step S6, the mode setter 42 switches an operation mode of the moving body 10 and moves the moving body 10 based on a corresponding one of operation modes (autonomous movement mode or manual operation mode).

When the moving body 10 has arrived at the final destination indicated in the route information generated by the route information generator 38 (YES in step S7), the process ends and the moving body 10 stops at the final destination. Meanwhile, the processes from step S3 onward are continued (NO in step S7) until the moving body 10 arrives at the final destination indicated in the route information. The moving body 10 may be configured to temporarily stop its movement or may terminate its movement partway through the process, even when the moving body 10 has not arrived at the final destination, when a certain amount of time elapses from the start of movement, when an obstacle is detected on the moving route, or when an operator receives a stop instruction.

Processes up to Start of Movement of the Moving Body

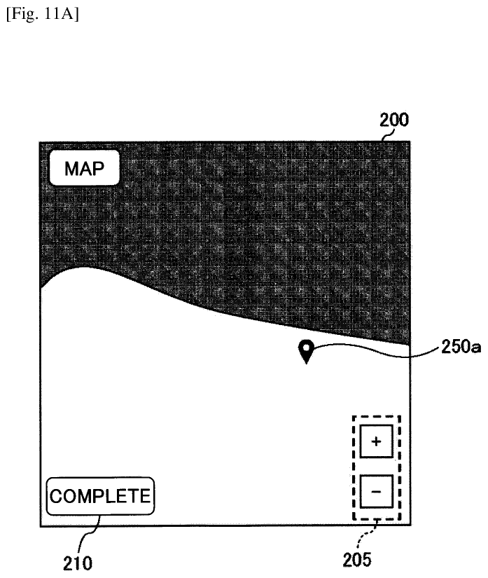

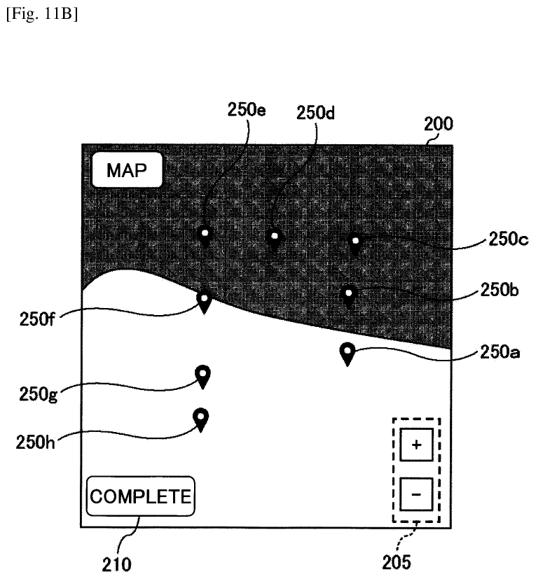

Next, processes up to the start of movement of the moving body 10 will be described with reference to FIGS. 10 to 11. FIG. 10 is a sequence diagram illustrating an example of processes up to the start of movement of the moving body.

First, in step S11, the transmitter-receiver 51 of the display device 50 transmits, to the moving body 10, a route input request indicating a request for inputting a moving route of the moving body 10, in response to a predetermined input operation of an operator or the like. The route input request includes a location ID identifying a location where the moving body 10 is located. Accordingly, the transmitter-receiver 31 of the control device 30 disposed in the moving body 10 receives the route input request transmitted from the display device 50.

Next, in step S12, the map information manager 35 of the control device 30 retrieves the map information management DB 3001 (see FIG. 6) by using the location ID received in step S11 as a retrieval key, and reads map information associated with the same location ID as the received location ID through the storing-reading unit 49. Herein, as illustrated in FIG. 6, a storage location of an environmental map downloaded in advance from an external server or the like or an environmental map created by applying SLAM and remotely controlling the moving body 10 is illustrated in the map information management DB 3001. The map information manager 35 accesses the storage location illustrated in the read map information and reads the cor-responding map image data.

Next, in step S13, the transmitter-receiver 31 transmits the map image data corre-sponding to the map information read in step S12 to the requester display device 50 that has transmitted the route input request. Accordingly, the transmitter-receiver 51 of the display device 50 receives the map image data transmitted from the moving body 10.

Next, in step S14, the display controller 53 of the display device 50 displays a route input screen 200 including the map image data received in step S13 on a display unit, such as the display device 506. FIG. 11 is a diagram illustrating an example of the route input screen. The route input screen 200 illustrated in FIG. 11 is a display screen for inputting a route for which an operator desires to move the moving body 10.

The route input screen 200 displays a map image relating to the map image data received in step S13. The map image pertaining to the map image data received in step S13 is displayed. The route input screen 200 includes a display selection button 205 that is pressed to enlarge or reduce the displayed map image, and a “complete” button 210 that is pressed to complete the route input process.

As illustrated in FIG. 11A, the route input screen 200 displays a destination series 250a by an operator using an input unit such as a pointing device 512 to select a predetermined position on the map image. The operator selects a position on the map image while viewing the map image displayed on the route input screen 200. Thus, the route input screen 200 displays a plurality of destination series 250a to 250h corresponding to a position selected by the operator, as illustrated in FIG. 11B.

As illustrated in FIG. 11B, when the operator selects a predetermined position on the map image and clicks the “complete” button 210, the reception unit 52 receives inputs of the destination series 250a to 250h (step S15). In step S16, the transmitter-receiver 51 transmits destination series data representing the destination series 250a to 250h received in step S15 to the moving body 10.

This destination series data includes location information that indicates the positions on the map image of the destination series 250a to 250h that has been received in step S15. Accordingly, the transmitter-receiver 31 of the control device 30 disposed in the moving body 10 receives the destination series data transmitted from the display device 50.

Next, in step S17, the destination series manager 36 of the control device 30 stores the destination series data received in step S16 in the destination series management DB 3002 (see FIG. 7) in association with the location ID received in step S11 through the storing-reading unit 49. The destination series manager 36 identifies a plurality of destination series (e.g., the destination series 250a to 250h) represented in the received destination series data by the series ID, and stores the location information representing the position of the corresponding destination series on the map image for each series ID.

Next, in step S18, the self-location estimator 37 estimates a current position of the moving body 10. Specifically, the self-location estimator 37 estimates the self-location (current position) of the moving body 10 by a method such as an extended Kalman filter using location information representing the position of the moving body 10 detected by the state detector 34 and direction information representing the direction of the moving body 10.

Next, in step S19, the route information generator 38 generates route information representing the moving route of the moving body 10 based on the self-location estimated in step S18 and the destination series data received in step S16. Specifically, the route information generator 38 sets the final destination (goal) and a plurality of waypoints (sub-goals) of the moving body 10 using the current position (self-location) of the moving body 10 estimated in step S18 and destination series data received in step S16. The route information generator 38 generates route information representing the moving route of the moving body 10 from the current position to the final destination. The route information generator 38 identifies a moving route using, for example, a method of connecting the waypoints from the current position to the final destination by a straight line or a method of minimizing the moving time while avoiding obstacles using the captured image or using obstacle information obtained by the 34. The route information manager 39 stores the route information generated by the route information generator 38 in the route information management DB 3003 (see FIG. 8) through the storing-reading unit 49 in association with the generated route information ID.

Next, in step S20, the destination setter 40 sets a moving destination of the moving body 10 based on the current position of the moving body 10 estimated in step S18 and the route information generated in step S19. Specifically, based on the estimated current position (self-location) of the moving body 10, the destination setter 40 sets a destination (current goal) to which the moving body 10 should move from among the destination series illustrated in the generated route information as the moving destination. The destination setter 40, for example, sets the destination series that is closest to the current position (self-location) of the moving body 10 as the moving destination of the moving body 10 among series of destinations at which” the moving body 10 has yet to arrive (e.g., the status is “unarrived”). Then, in step S21, the movement controller 41 starts the moving process of the moving body 10 to the destination set in step S20 (step S21). In this case, the movement controller 41 autonomously moves the moving body 10 in response to a driving instruction from the autonomous moving processor 43.

As described above, the communication system 1 can autonomously move the moving body 10 based on a moving route generated in response to a destination series input by an operator. Note that an example of selecting a destination series by selecting a position on the map image displayed on the route input screen 200 has been described in step S15. However, the route input screen 200 may be configured to display a plurality of previously captured images, which are learned data by the learning unit 47, and an operator may select a displayed captured image so as to select a destination series corresponding to the captured position of the captured image. In this case, the destination series data includes information that identifies the selected captured image in place of the location information. The destination series management DB 3002 stores the identification information of the captured images in place of the location information.

### Movement Control by the Operator for Moving Body

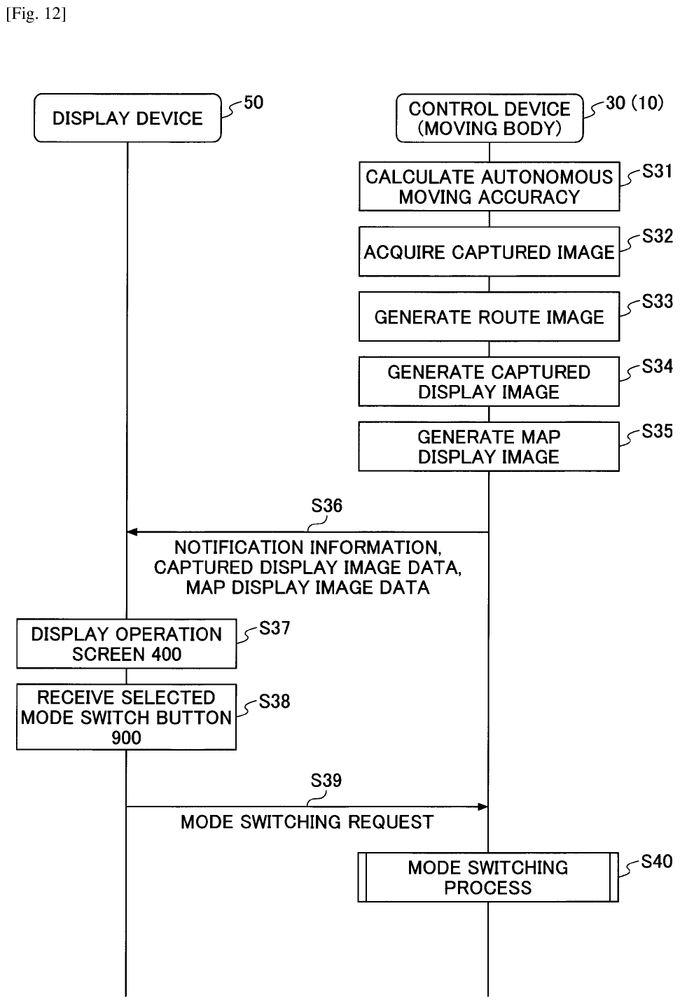

Next, a control process for the moving body 10 in a moving state through a remote operation by an operator will be described with reference to FIGS. 12 to 19. FIG. 12 is a sequence diagram illustrating an example a switching process between an autonomous movement of a moving body and a manual operation, using an operation screen. FIG. 12 illustrates an example where the moving body 10 has started autonomous movement within the location by the process illustrated in FIG. 10. First, in step S31, the accuracy calculator 45 of the control device 30 disposed in the moving body 10 calculates the autonomous movement accuracy of the moving body 10. The accuracy calculator 45 calculates the autonomous movement accuracy based on, for example, route information generated by the route information generator 38 and the current position of the moving body 10 estimated by the self-location estimator 37. The accuracy of the autonomous movement of the moving body 10 is information that indicates the confidence factor (confidence degree) that the moving body 10 is capable of moving autonomously. The higher the calculated value, the more the moving body 10 is capable of moving autonomously. The accuracy calculator 45 may calculate the autonomous movement accuracy based on, for example, the learned data by the learning unit 47 and the current position of the moving body 10 estimated by the self-location estimator 37. In this case, the accuracy of the autonomous movement of the moving body 10 is information indicating learning accuracy of the autonomous movement.

The accuracy calculator 45 may calculate the autonomous movement accuracy by lowering the numerical value when the likelihood becomes low based on the numerical value of the likelihood of the self-location estimated by the self-location estimator 37, or by lowering the numerical value when the variance is large using the variance of various sensors, etc. Further, the accuracy calculator 45 may calculate the autonomous movement accuracy, for example, using the movement elapsed time, which is the state of operation by the autonomous moving processor 43, to reduce the numerical value as the movement elapsed time in the autonomous movement mode becomes longer, or to reduce the numerical value as the distance becomes larger according to the distance between the destination series and the moving body 10. The accuracy calculator 45 may also calculate the autonomous movement accuracy, for example, by lowering the numerical value when there are many obstacles according to the information of obstacles detected by the state detector 34.

In step S32, the imaging controller 33 performs imaging process using the imaging device 12 while moving within the location. In step S33, the image generator 46 generates a virtual route image to be displayed on the captured image acquired by the imaging process in step S32. The route image is generated based on, for example, the current position of the moving body 10 estimated by the self-location estimator 37 and the location information and status of the destination series stored on a per destination series basis in the destination series management DB 3002. In step S34, the image generator 46 also generates a captured display image in which the route image generated in step S33 is rendered on the captured image acquired in step S32.

Furthermore, in step S35, the image generator 46 generates a map display image in which a current position display image representing a current position of the moving body 10 (self-location) estimated by the self-location estimator 37 and a series image representing the destination series received in step S16 are rendered on the map image read in step S12.

The order the process of steps S31 to S35 may be reversed, or the order the process of steps S31 to S35 may be performed in parallel. The moving body 10 continuously performs the process from step S31 to step S35 while moving around the location. The moving body 10 generates various information for presenting to an operator whether or not autonomous movement of the moving body 10 is successfully performed by process from step S31 to step S35.

Next, in step S36, the transmitter-receiver 31 transmits to the display device 50 noti-fication information representing the autonomous movement accuracy calculated in step S31, the captured display image data generated in step S34, and the map display image data generated in step S35. Thus, the transmitter-receiver 51 of the display device 50 receives the notification information, the captured display image data, and the map display image data transmitted from the moving body 10.

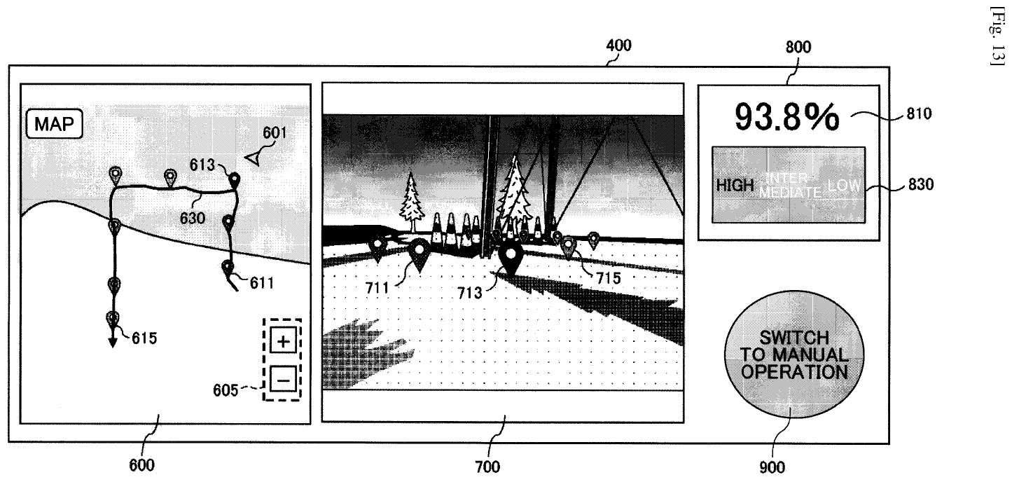

Next, in step S37, the display controller 53 of the display device 50 causes an operation screen 400 to be displayed on a display unit such as the display 106. FIG. 13 is a diagram illustrating an example of an operation screen. The operation screen 400 illustrated in FIG. 13 is an example of a GUI through which an operator remotely operates the moving body 10.

The operation screen 400 includes a map display image area 600 for displaying the map display image data received in step S36, a captured display image area 700 for displaying the captured display image data received in step S36, a notification information display area 800 for displaying the notification information received in step S36, and a mode switching button 900 for receiving a switching operation for switching between an autonomous movement mode and a manual operation mode.

Of these, the map display image displayed in the map display image area 600 is an image in which a current position display image 601 representing the current position of the moving body 10, the series images 611, 613 and 615 representing the destination series constituting the moving route of the moving body 10, and a trajectory display image representing a trajectory of the moving route of the moving body 10 are su-perimposed on the map image. The map display image area 600 also includes a display selection button 605 that is pressed to enlarge or reduce the size of the displayed map image.

The series images 611, 613, and 615 display the destination series on the map image such that the operator can identify the moving history representing the positions to which the moving body 10 has already moved, the current destination, and the future destination. Of these, the series image 611 illustrates a destination series at which the moving body 10 has already arrived. The series image 613 also illustrates a destination series that is the current destination of the moving body 10. In addition, the series image 615 illustrates an unarrived destination (future destination) at which the moving body 10 has yet arrived. In the process of step S35, the series images 611, 613, and 615 are generated based on the status of the destination series stored in the destination series management DB 3002.

The captured display image displayed in the captured display image area 700 includes route images 711, 713, and 715 that virtually represent a moving route of the moving body 10 generated in the process of step S33. The displayed route images 711, 712, and 715 enable the operator to identify a series of destinations corresponding to the location(s) represented by the captured image as a moving history indicating where the moving body 10 has already moved, as a current destination, and as future des-tinations. The route images 711, 713, and 715 display the destination series corre-sponding to positions of the locations in the captured images, which can be identified by the operator as the moving history representing the positions to which the moving body 10 has already moved, the current destination, and the future destination. Of these, the route image 711 illustrates series of destinations at which” the moving body 10 has already arrived. The route image 713 also illustrates a destination series that is the current destination of the moving body 10. Additionally, the route image 715 illustrates the unarrived destination (future destination) at which the moving body 10 has yet arrived. The route images 711, 713, and 715 are generated based on the status of the destination series stored in the destination series management DB 3002 in the process of step S33. Herein, a map image and a captured image are examples of images indicating a location in which the moving body 10 is installed. In addition, the map display image displayed on the map display image area 600 and the captured display image displayed on the captured display image area 700 are examples of a location display image representing the moving route of the moving body 10 in an image representing a location. The captured display image area 700 may display the captured images by the imaging device 12 as live streaming images distributed in real time through a computer network such as the Internet.

The notification information display area 800 displays information on the autonomous movement accuracy illustrated in the notification information received in step S36. The notification information display area 800 includes a numerical value display area 810 that displays information on the autonomous movement accuracy as a numerical value (%), and a degree display area 830 that discretizes the numerical value indicating the autonomous movement accuracy and displays the discretized numerical value as an autonomous movement degree. The numerical value display area 810 indicates the numerical value of the autonomous movement accuracy calculated in the process of step S31. The degree display area 830 indicates a degree of the autonomous movement accuracy (“high, medium, low”) according to the numerical value, with a predetermined threshold set for the numerical value of autonomous movement accuracy. Herein, the numerical value indicating the accuracy of autonomous movement illustrated in the numerical value display area 810 and the degree of autonomous movement illustrated in the degree display area 830 are examples of noti-fication information representing the accuracy of autonomous movement. The noti-fication information display area 800 may include at least one of the numerical value display area 810 and the degree display area 830.

The mode switching button 900 is an example of an operation reception unit configured to receive a switching operation that switches between an autonomous movement mode and a manual operation mode. The operator can switch between the autonomous movement mode and the manual operation mode of the moving body 10 by selecting the mode switching button 900 using a predetermined input unit.

In the example illustrated in FIG. 13, the operation screen 400 displays a state in which the moving body 10 is moving autonomously with the position of the series image 613 and the position of the route image 713 as the current destination of the moving body 10. The operation screen 400 also indicates that the current autonomous movement accuracy of the moving body 10 is “93.8%”, which is a relatively high autonomous movement accuracy.

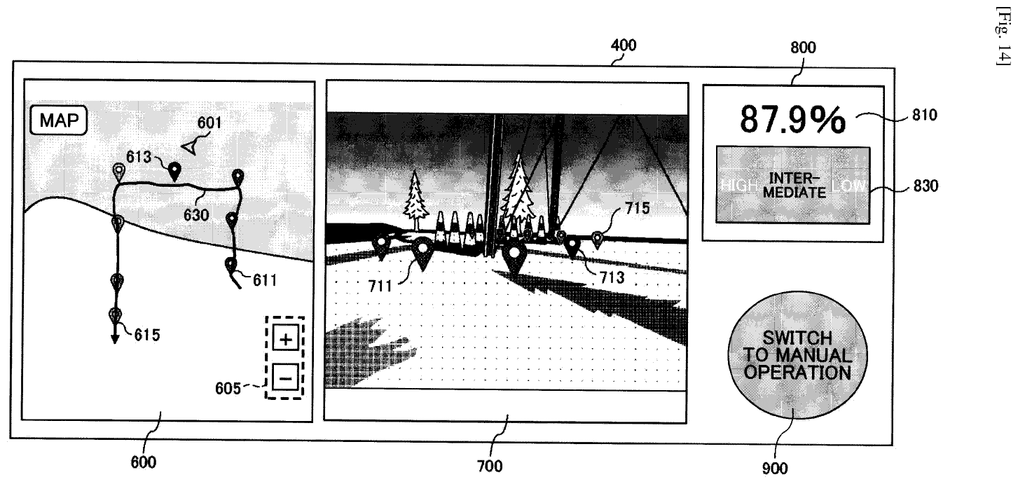

FIG. 14 illustrates a state in which the moving body 10 has moved from the state illustrated in FIG. 13. In the operation screen 400 illustrated in FIG. 14, since the moving body 10 has moved from the state illustrated in FIG. 13, positions of the series image 613 and the route image 713 representing a current destination have been changed. Further, in the operation screen 400 illustrated in FIG. 14, the accuracy of the current autonomous movement of the moving body 10 is “87.9%”, the numerical value of the autonomous movement accuracy is lower than the numerical value of the autonomous movement accuracy in the state illustrated in FIG. 13, and the degree of the autonomous movement accuracy is changed from “high” to “intermediate”. The operator can determine whether or not to switch between the autonomous movement and the manual operation of the moving body 10 by viewing the status of the location illustrated in the map display image and the location display image illustrated on the operation screen 400, and the change in the autonomous movement accuracy illustrated in the notification information display area 800.

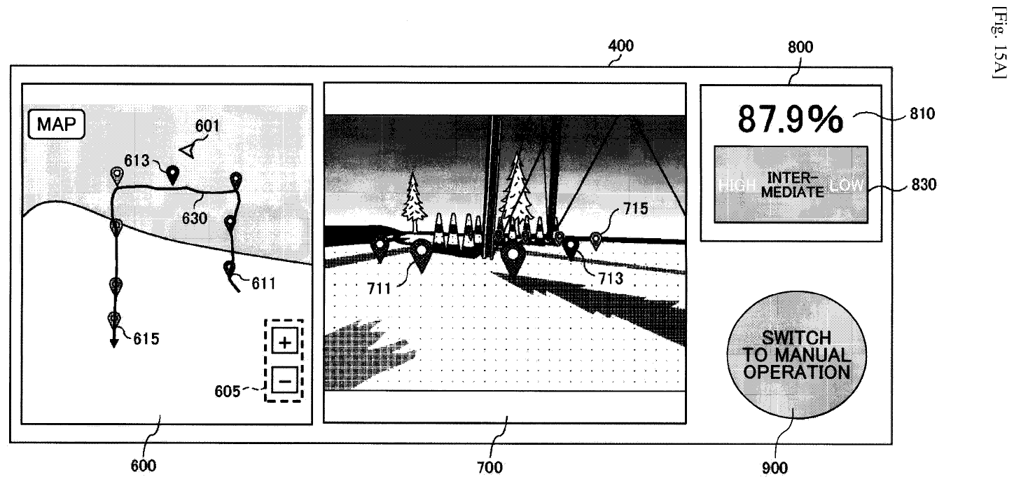

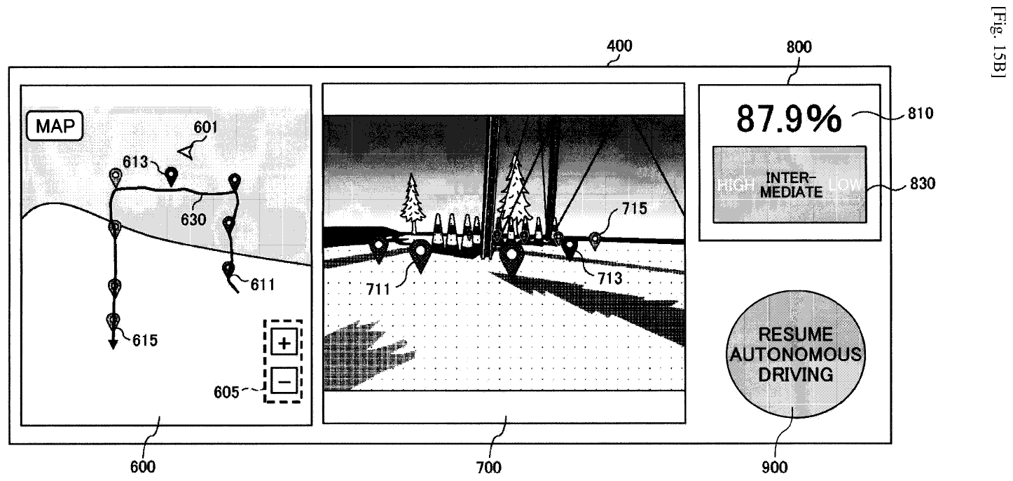

Returning to FIG. 12, in step S38, the reception unit 52 receives a selection of the mode switching button 900 on the operation screen 400 in response to an input operation using an input unit such as an operator's pointing device 512. In the operation screen 400, for example, when an operator selects the mode switching button 900 (displayed as “switch to manual operation”) in the state illustrated in FIG. 15A, a display of the mode switching button 900 in the state illustrated in FIG. 15A is changed to the mode switching button 900 (displayed as “resume autonomous driving”) as illustrated in FIG. 15B. In this case, the operator selects the mode switching button 900 in order to switch the operation mode of the moving body 10 from the autonomous movement mode to the manual operation mode.

In step S39, the transmitter-receiver 51 transmits to the moving body 10 a mode switching request indicating that the moving body 10 requests the switching between the autonomous movement mode and the manual operation mode. Accordingly, the transmitter-receiver 31 of the control device 30 disposed in the moving body 10 receives the mode switching request transmitted from the display device 50.

Next, in step S40, the control device 30 performs the mode switching process of the moving body 10 in response to the receipt of the mode switching request in step S39.

(Selecting of Autonomous Movement and Manual Operation)

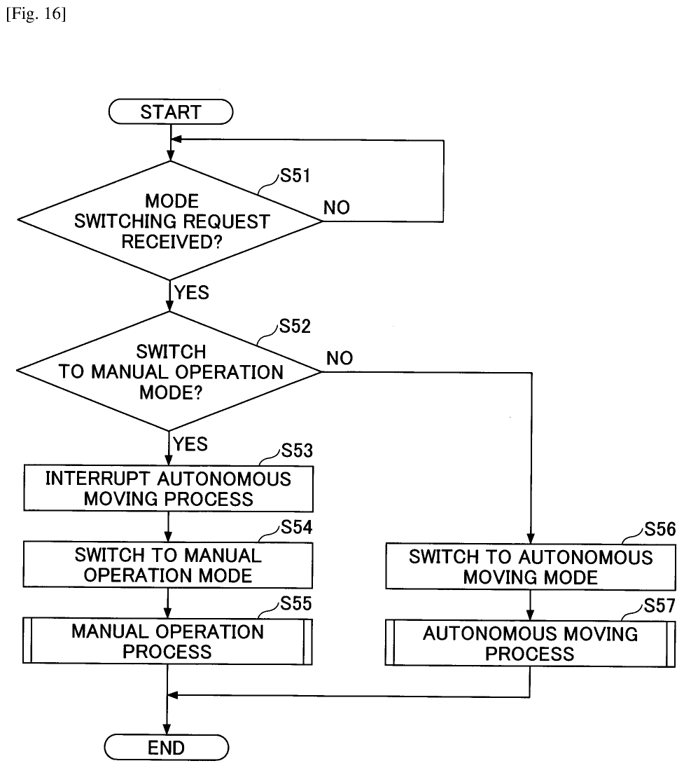

Herein, the mode switching process in step S40 will be described in detail with reference to FIG. 16. FIG. 16 is a flowchart illustrating an example of a switching process between the autonomous movement mode and the manual operation mode in a moving body.

First, when the mode switching request transmitted from the display device 50 by the transmitter-receiver 31 is received (YES in step S51), the control device 30 transits the process to step S52. Meanwhile, the control device 30 continues the process of step S51 (NO in step S51) until a mode switching request is received.

Next, when the received mode switching request indicates switching to the manual operation mode (YES in step S52), the mode setter 42 transits the process to step S53. In step S53, the movement controller 41 stops the autonomous moving process of the moving body 10 in response to a stop instruction of the autonomous moving process from the autonomous moving processor 43. In step S54, the mode setter 42 switches the operation of the moving body 10 from the autonomous movement mode to the manual operation mode. In step S55, the movement controller 41 performs movement of the moving body 10 by manual operation in response to a drive instruction from the manual operation processor 44.

Meanwhile, when the received mode switching request does not indicate switching to the manual operation mode, that is, when the received mode switching request indicates switching to the autonomous movement mode, that is, when the switching request indicates switching to the autonomous movement mode (NO in step S52), the mode setter 42 transits the process to step S56. In step S56, the mode setter 42 switches the operation of the moving body 10 from the manual operation mode to the autonomous movement mode. In step S57, the movement controller 41 performs movement of the moving body 10 by autonomous movement in response to a driving instruction from the autonomous moving processor 43.

As described above, the display device 50 displays the operation screen 400 including the notification information representing the autonomous movement accuracy of the moving body 10, so that the operator can appropriately determine whether or not to switch between the autonomous movement and the manual operation. Further, the display device 50 improves operability when an operator switches between the autonomous movement and the manual operation by having an operator perform the switching between the autonomous movement and the manual operation using the mode switching button 900 on the operation screen 400, which includes the notification information representing autonomous movement accuracy. The moving body 10 can perform movement control according to an operator's request by switching between the autonomous movement mode and the manual operation mode, in response to a switching request transmitted from the display device 50.

The moving body 10 may be configured not only to switch the operation mode in response to the switching request transmitted from the display device 50, but may also be configured to switch the operation mode from the autonomous movement mode to the manual operation mode when the numerical value of the autonomous movement accuracy falls below the predetermined threshold value in response to the autonomous movement accuracy calculated by the accuracy calculator 45.

The display device 50 may include not only a unit for displaying of the operation screen 400 but also include a unit for notifying an operator of the degree of autonomous movement accuracy. For example, the sound output unit 55 of the display device 50 may be configured to output a warning sound from the speaker 515 when the value of autonomous movement accuracy falls below a predetermined threshold value.

The display device 50 may be configured to vibrate an input unit such as a controller used for manual operation of the moving body when the value of autonomous movement accuracy falls below the predetermined threshold value.

Further, the display device 50 may display a predetermined message based on a value or degree of autonomous movement accuracy as notification information rather than directly displaying autonomous movement accuracy on the operation screen 400. In this case, for example, when the numerical value or the degree of autonomous movement accuracy falls below the predetermined threshold value, the operation screen 400 may display a message requesting an operator to switch to the manual operation. The operation screen 400 may, for example, display a message prompting an operator to switch from manual operation to autonomous movement when the numerical value or the degree of autonomous movement accuracy exceeds the predetermined threshold value.

Autonomous Moving process

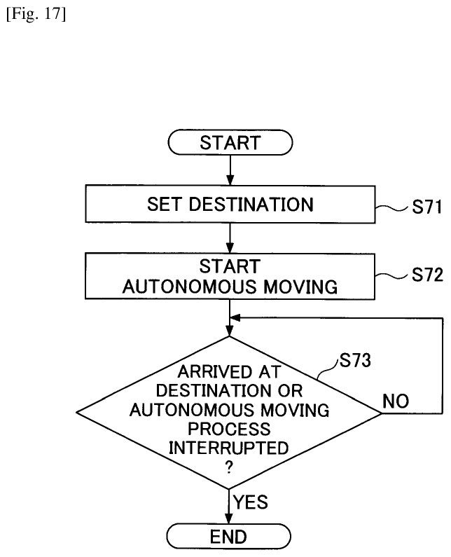

Next, an autonomous moving process of the moving body 10 performed by the process illustrated in step S57 will be described with reference to FIG. 17. FIG. 17 is a flowchart illustrating an example of an autonomous moving process of a moving body.

First, in step S71, the destination setter 40 of the control device 30 disposed in the moving body 10 sets a moving destination of the moving body 10 based on the current position of the moving body 10 estimated by the self-location estimator 37 and the route information stored in the route information management DB 3003 (see FIG. 8). Specifically, the destination setter 40 sets a position represented by the destination series closest to the current position of the moving body 10 estimated by the self-location estimator 37 as the moving destination, from among the destination series rep-resented by the route information stored in the route information management DB 3003. In the example illustrated in FIG. 7, the position of the destination series with the series ID “P003” whose status is the current destination is set as the moving destination. The destination setter 40 generates a moving route to a set moving destination. An example of a method of generating the moving route by the destination setter 40 includes a method of connecting the current position and the moving destination with a straight line or a method of minimizing the moving time while avoiding obstacles by using the captured image or obstacle information obtained by the state detector 34.

The movement controller 41 moves the moving body 10 with respect to a moving destination, to which the moving body 10 is set to pass through the moving route generated in step S71. In this case, the movement controller 41 moves the moving body 10 autonomously in response to a drive instruction from the autonomous moving processor 43. In step S72, the autonomous moving processor 43 performs autonomous movement based on learned data that is a result of simulation learned by the learning unit 47.

When the moving body 10 has arrived at its final destination or autonomous movement by the autonomous moving processor 43 is interrupted (YES in step S73), the movement controller 41 ends the process. When autonomous movement is in-terrupted, for example, by the mode setter 42 to perform switching from the autonomous movement mode to the manual operation mode in response to a switching request from the autonomous movement mode to the manual operation mode, as illustrated in FIG. 16. Meanwhile, the movement controller 41 continues the autonomous moving process in step S72 (NO in step S73) until the movement controller 41 detects that the moving body 10 has arrived at its final destination or that autonomous movement is interrupted by the autonomous moving processor 43.

As described above, the moving body 10 can perform autonomous movement using the generated route information and learned data learned during the manual operation mode at the time of operation in the autonomous movement mode set in response to a switching request from the operator. Further, the moving body 10 can perform autonomous movement of the moving body 10 using the learned data and improve the accuracy of autonomous movement of the moving body 10 by performing learning on autonomous movement using various types of data acquired during the manual operation mode.

Manual Operation Process

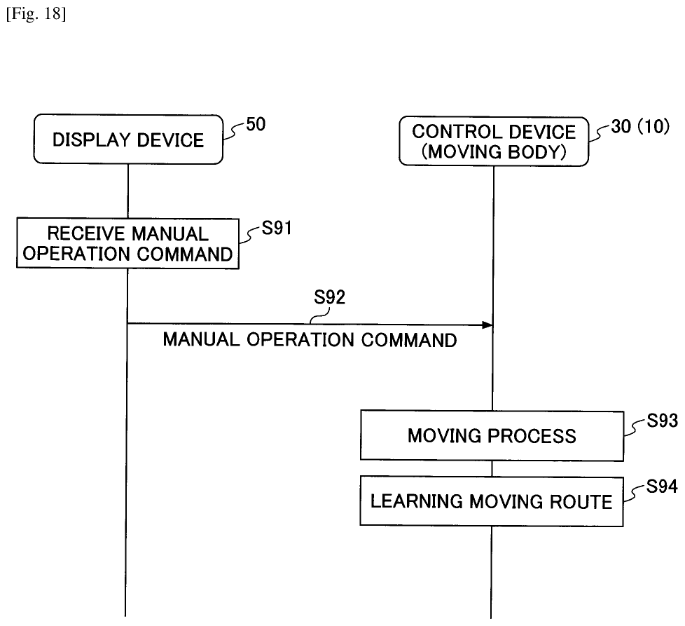

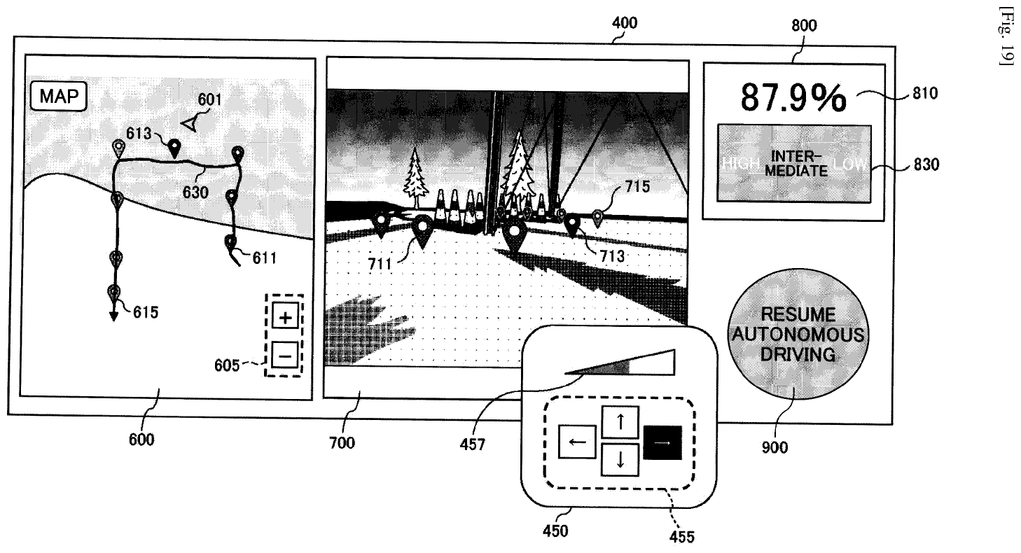

Next, the manual operation process of the moving body 10 performed by the process illustrated in step S55 will be described with reference to FIGS. 18 and 19. FIG. 18 is a sequence diagram illustrating an example of a manual operation process of the moving body.

First, in step S91, the reception unit 52 of the display device 50 receives a manual operation command in response to an operator's input operation to the operation command input screen 450 illustrated in FIG. 19. FIG. 19 is a diagram illustrating an example of an operation command input screen. The operation command input screen 450 illustrated in FIG. 19 is illustrated with an icon for remotely controlling the moving body 10. The operation command input screen 450 is displayed on the operation screen 400, for example, when the operation mode of the moving body 10 is set to the manual operation mode. The operation command input screen 450 includes a movement instruction key 455, which is depressed when a horizontal (forward, backward, clockwise, and counterclockwise) movement of the moving body 10 is requested, and a speed bar 457, which is represented by a movement speed indicating the state of the movement speed of the moving body 10. When an operator who remotely operates the moving body 10 using the display device 50 selects the movement instruction key 455, the reception unit 52 receives a manual operation command for the selected movement instruction key 455.

FIG. 19 illustrates an example of remotely controlling the movement of the moving body 10 by receiving a selection for the movement instruction key 455 displayed on the operation command input screen 450. However, the movement operation of the moving body 10 may be performed by a special-purpose controller, such as a keyboard or a game pad with a joystick. In addition, in the input operation of the movement instruction key 455 by an operator, when the operator selects “rearward (↓)” while the moving body 10 is moving forward, the captured image may be switched to a captured image of a rearward screen of the moving body 10 and the moving body 10 may be moved rearward (backward) from that point on. The transmission of the manual operation command from the display device 50 to the moving body 10 may also be performed via a managed cloud platform such as, for example, AWS IoT Core.

Next, in step S92, the transmitter-receiver 51 transmits the manual operation command received in step S91 to the moving body 10. Accordingly, the transmitter-receiver 31 of the control device 30 disposed in the moving body 10 receives the manual operation command transmitted from the display device 50. The manual operation processor 44 of the control device 30 outputs the drive instruction based on the manual operation command received in step S92 to the movement controller 41. In step S93, the movement controller 41 performs a moving process of the moving body 10 in response to a drive instruction by the manual operation processor 44. In step S94, the learning unit 47 performs simulation learning (machine learning) of the moving route in response to the manual operation by the manual operation processor 44. The learning unit 47, for example, simulates the moving route relating to autonomous movement based on the captured image acquired during the movement in the manual operation mode by the manual operation processor 44 and the detection data by the state detector 34. The learning unit 47 may be configured to perform simulation learning of a moving route using only the captured image acquired during the manual operation, or the learning unit 47 may be configured to perform simulation learning of a moving route using both the captured image and the detection data by the state detector 34. The captured image used for simulation learned by the learning unit 47 may be a captured image acquired during autonomous movement in the autonomous movement mode by the autonomous moving processor 43.

As described above, when the moving body 10 is operated in the manual operation mode set in response to a switching request from the operator, the moving body 10 can be moved in response to the manual operation command from the operator. The moving body 10 can learn about autonomous movement using various data such as captured images acquired in the manual operation mode.

### Modification of Operation Screen

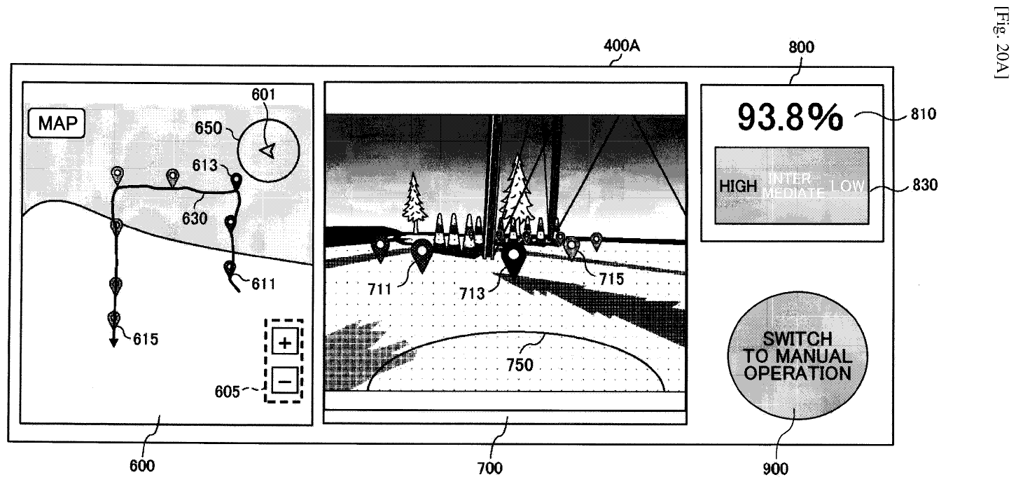

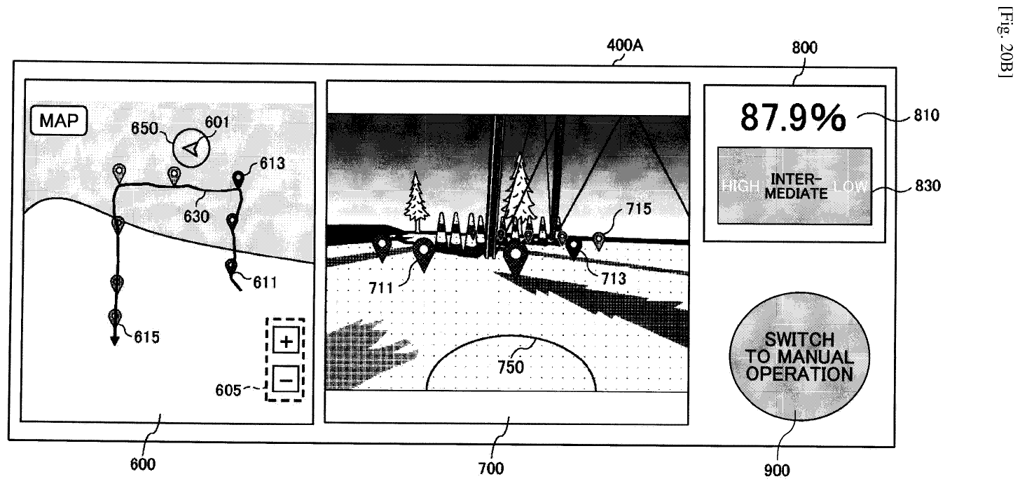

Next, a modification of the operation screen 400 displayed on the display device 50 will be described with reference to FIGS. 20 to 25. FIG. 20 is a diagram illustrating a first modification of the operation screen. An operation screen 400A illustrated in FIG. 20 is configured to display notification information representing autonomous movement accuracy in the map display image area 600 and in the captured display image area 700 in addition to the configuration of the operation screen 400.

The map display image displayed in the map display image area 600 of the operation screen 400A includes an accuracy display image 660 indicating a degree of autonomous movement accuracy on the map image, in addition to the configuration displayed in the map display image area 600 of the operation screen 400. Similarly, the captured display image displayed in the captured display image area 700 of the operation screen 400A includes an accuracy display image 760 indicating a degree of autonomous movement accuracy on the captured image, in addition to the configuration displayed in the captured display image area 700 of the operation screen 400. Accuracy display images 660 and 760 illustrate the degree of autonomous movement accuracy in circles. For example, the accuracy display images 660 and 760 represent uncertainty of autonomous movement or self-location by decreasing the size of the circle as the autonomous movement accuracy is increased, and by increasing the size of the circle as the autonomous movement accuracy is decreased. Herein, the accuracy display image 660 and the accuracy display image 760 are examples of noti-fication information representing the accuracy of autonomous movement. The accuracy display images 660 and 760 may be configured to represent the degree of the autonomous movement accuracy by a method such as changing the color of a circle according to the degree of autonomous movement accuracy.

The accuracy display image 660 is generated by being rendered on a map image by the process in step S35 based on a numerical value of autonomous movement accuracy calculated by the accuracy calculator 45. Similarly, the accuracy display image 760 is generated by being rendered on the captured image by the process in step S34 based on a numerical value of the autonomous movement accuracy calculated by the accuracy calculator 45. The operation screen 400A displays a map display image in which the accuracy display image 660 is superimposed on the map image and a captured display image in which the accuracy display image 760 is superimposed on the captured image.

As described above, the operation screen 400A displays an image representing the autonomous movement accuracy on the map image and the captured image, so that the operator can intuitively understand the accuracy of the autonomous movement of the current moving body 10 while viewing a moving condition of the moving body 10.

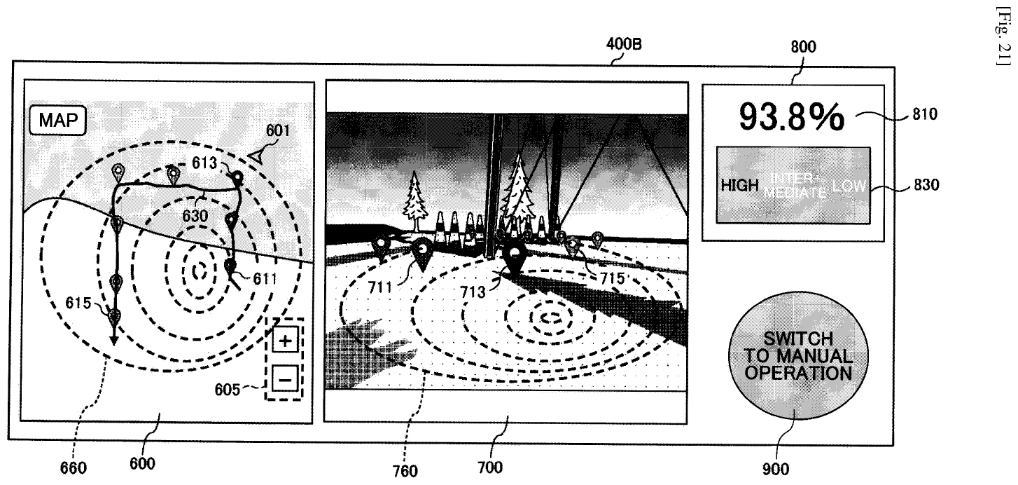

FIG. 21 is a diagram illustrating a second modification of the operation screen. An operation screen 400B illustrated in FIG. 21 displays notification information representing autonomous movement accuracy in the map display image area 600 and the captured display image area 700 in a manner similar to the operation screen 400A, in addition to the configuration of the operation screen 400.

The map display image displayed in the map display image area 600 of the operation screen 400B includes an accuracy display image 670 indicating a degree of autonomous movement accuracy on the map image, in addition to the configuration displayed on the map display image area 600 of the operation screen 400. Similarly, the captured display image displayed in the captured display image area 700 of the operation screen 400B includes an accuracy display image 770 indicating a degree of autonomous movement accuracy on the captured image, in addition to the configuration displayed on the captured display image area 700 of the operation screen 400. The accuracy display images 670 and 770 represent the degree of autonomous movement accuracy in a contour diagram. The accuracy display images 670 and 770 represent, for example, the degree of autonomous movement accuracy at respective positions on a map image and on a captured image, as contour lines. Herein, the accuracy display image 670 and the accuracy display image 770 are examples of noti-fication information representing the accuracy of autonomous movement. The accuracy display images 670 and 770 may be configured to indicate the degree of the autonomous movement accuracy by a method such as changing the color of the contour line according to the degree of autonomous movement accuracy.

The accuracy display image 670 is generated by being rendered on a map image by the process in step S35 based on the numerical value of autonomous movement accuracy calculated by the accuracy calculator 45. Similarly, the accuracy display image 770 is generated by being rendered on the captured image by the process in step S34 based on the numerical value of the autonomous movement accuracy calculated by the accuracy calculator 45. The operation screen 400B displays a map display image in which the accuracy display image 670 is superimposed on the map image and a captured display image in which the accuracy display image 770 is superimposed on the captured image.

As described above, the operation screen 400B displays an image with a contour line representing autonomous movement accuracy on the map image and the captured image, to clarify which area has low autonomous movement accuracy, and the operation screen 400B can visually assist an operator to drive the moving body 10 to pass through the route with high autonomous movement accuracy when the moving body 10 is manually operated by the operator. When machine learning or the like is used to improve autonomous movement performance for each manual operation, the communication system 1 can expand the area in which autonomous movement is possible by the operator to manually move the moving body 10 in a place where autonomous movement accuracy is low to accumulate learned data while the operator views a contour diagram indicating autonomous movement accuracy.

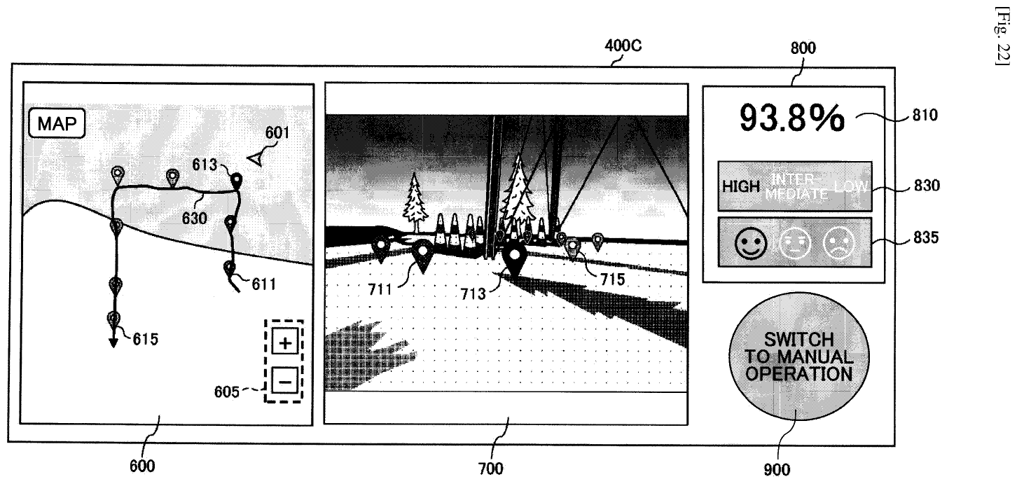

FIG. 22 is a diagram illustrating a third modification of an operation screen. An operation screen 400C illustrated in FIG. 22 displays the degree of autonomous movement accuracy in the notification information display area 800 with different face images in stages, in addition to the configuration of the operation screen 400.

The notification information display area 800 of the operation screen 400C includes a degree display area 835 that indicates the degree of autonomous movement as a face image, in addition to a configuration displayed in the notification information display area 800 of the operation screen 400. The degree display area 835, in a manner sub-stantially the same as that of the degree display area 830, discretizes the numerical value indicating the autonomous movement accuracy and displays the discretized numerical value as the degree of autonomous movement. The degree display area 835 includes a predetermined threshold value set for the autonomous movement accuracy value, and switches a facial expression of the face image according to the autonomous movement accuracy value calculated by the accuracy calculator 45. Here, the face image illustrated in the degree display area 835 is an example of the notification information representing the accuracy of autonomous movement. The degree display area 835 is not limited to being configured to display a face image, but may also be configured to display an image of a predetermined illustration that allows the operator to recognize the degree of autonomous movement accuracy in stages.

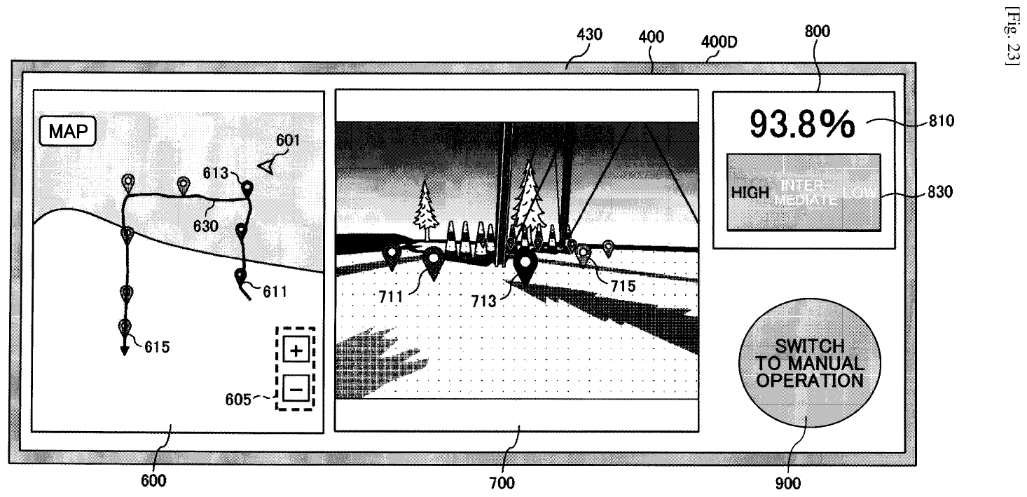

FIG. 23 is a diagram illustrating a fourth modification of an operation screen. An operation screen 400D illustrated in FIG. 23 displays autonomous movement accuracy in colors in the frame of the operation screen in addition to the configuration of the operation screen 400.

The operation screen 400D includes, in addition to the configuration of the operation screen 400, a screen frame display area 430 for converting a degree of autonomous movement accuracy into a color and displaying the converted degree of autonomous movement accuracy as a screen frame. The screen frame display area 430 changes the color of the screen frame according to the degree of autonomous movement accuracy. The screen frame display area 430 changes the color of the screen frame according to a numerical value of the autonomous movement accuracy calculated by the accuracy calculator 45 with a predetermined threshold value being set for the numerical value of the autonomous movement accuracy. For example, when the autonomous movement accuracy is low, the screen frame display area 430 displays the color of the screen frame in red, and when the autonomous movement accuracy is high, the screen frame display area 430 displays the color of the screen frame in blue. Herein, the color of the screen frame illustrated in the screen frame display area 430 is an example of the noti-fication information representing the accuracy of autonomous movement. The operation screen 400D may be configured to change the color of not only the screen frame but also the entire operation screen according to the degree of autonomous movement accuracy.

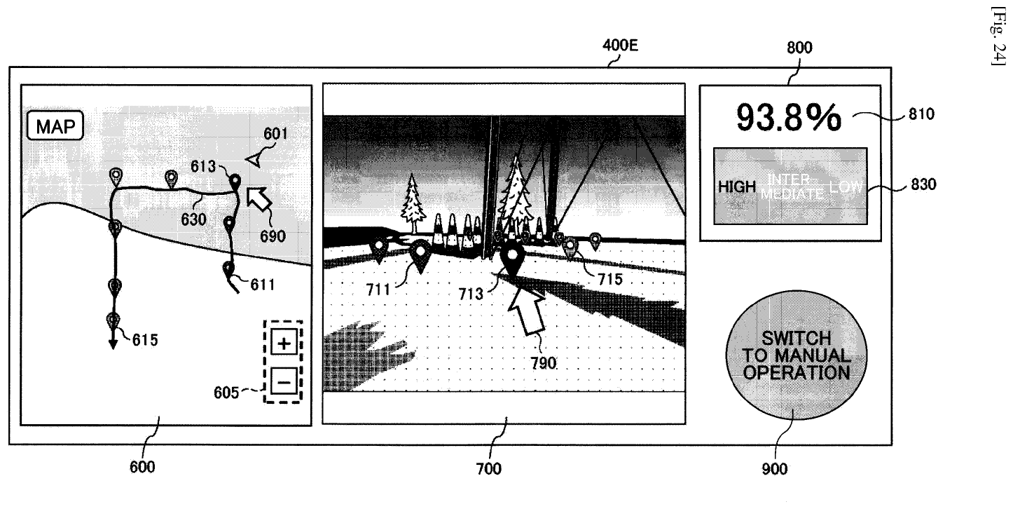

FIG. 24 is a diagram illustrating a fifth modification of an operation screen. An operation screen 400E illustrated in FIG. 24 illustrates a direction in which the moving body 10 should be directed during manual operation of the map display image area 600 and the captured display image area 700 in addition to the configuration of the operation screen 400.

The map display image displayed on the map display image area 600 of the operation screen 400E includes a direction display image 690 with an arrow indicating the direction in which the moving body 10 should be directed when manually operating on the map image, in addition to the configuration displayed on the map display image area 600 of the operation screen 400. Similarly, the captured display image displayed in the captured display image area 700 of the operation screen 400E includes a direction display image 790 representing an arrow representing a direction in which the moving body 10 should be directed when manually operating the captured image, in addition to the configuration displayed in the captured display image area 700 of the operation screen 400. The direction in which the moving body 10 should be directed during manual operation is, for example, the direction that indicates an area with high autonomous movement accuracy, and is the direction that will guide the moving body 10 to a position where the moving body 10 has a high possibility of resuming autonomous movement. The direction display images 690 and 790 are not limited to displays using arrows, but can be configured to allow the operator to identify the direction in which the moving body 10 should be directed during manual operation.

In this manner, the operation screen 400E allows the operator to visually identify the direction in which the moving body 10 should be moved by displaying the direction in which the moving body 10 should be directed during manual operation on the map image and the captured image.

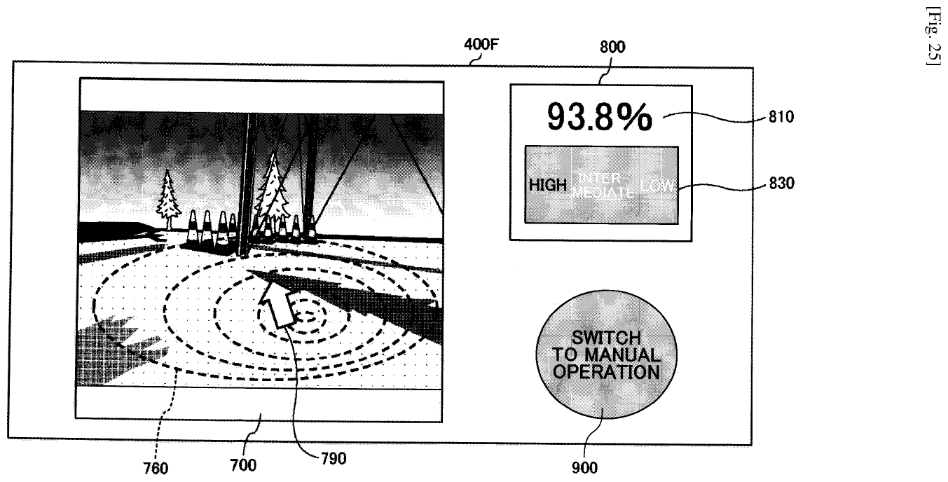

FIG. 25 is a diagram illustrating a sixth modification of an operation screen. An operation screen 400F illustrated in FIG. 25 displays the captured display image area 700, the notification information display area 800, and the mode switching button 900 without displaying the map display image area 600 displayed on each of the above-described operation screens.

Of these, the captured display image displayed in the captured display image area 700 of the operation screen 400F includes the accuracy display image 760 illustrated on the operation screen 400B and the direction display image 690 illustrated on the operation screen 400E that are displayed on the captured image. In addition, unlike the above-described operation screens, in the captured display image displayed on the operation screen 400F, the route images 711, 713, and 715 are not displayed on the captured image. The notification information display area 800 and the mode switching button 900 are similar to the configurations displayed on the operation screen 400.

As described above, the operation screen 400F displays at least the captured image captured by the moving body 10 and notification information representing the autonomous movement accuracy of the moving body 10, so that the operator can un-derstand the moving state of the moving body 10 using the minimum necessary information. The operation screen 400F may have a configuration in which the elements displayed in the captured display image area 700 and the elements displayed in the no-tification information display area 800 are displayed on each of the above-described operation screens, in addition to or in place of the elements illustrated in FIG. 25.

Effect of Embodiments

As described above, the communication system 1 displays, using a numerical value or an image, notification information representing the autonomous movement accuracy of the moving body 10 on the operation screen used by an operator. This enables the operator to easily determine whether to switch between the autonomous movement and the manual operation. The communication system also enables the operator to switch between the autonomous movement and the manual operation using the mode switching button 900 on the operation screen, which displays notification information representing the autonomous movement accuracy. This will improve the operability when the operator switches between the autonomous movement and the manual operation.

Furthermore, the communication system 1 can switch between an autonomous movement mode and a manual operation mode of the moving body 10 in response to a switching request of an operator. This allows for switching control between the autonomous movement and the manual operation of the moving body 10, in response to the operator's request. In addition, the communication system 1 enables the operator to appropriately determine the necessity of learning by manual operation for the moving body 10 that learns about autonomous movement using the captured images, and the like acquired in the manual operation mode.

Herein, each of the above-mentioned operation screens may be configured to display at least notification information representing the autonomous movement accuracy of the moving body 10 and a mode switching button 900 for receiving a switching operation between the autonomous movement mode and the manual operation mode. Of these, the mode switching button 900 may be substituted by the keyboard 511 or other input units of the display device 50, without being displayed on the operation screen. The communication system 1 may be configured to include an external input unit, such as a dedicated button to receive a switching operation between the autonomous movement mode and manual operation mode, disposed outside the display device 50. In these cases, an input unit, such as a keyboard 511 of the display device 50, or an external input unit, such as a dedicated button external to the display device 50, is an example of an operation reception unit. Furthermore, the display device 50 that displays an operation screen including a mode switching button 900, the display device 50 that receives a switching operation using an input unit such as a keyboard 511, or the system that includes the display device 50 and an external input unit such as a dedicated button are examples of the display system according to the em-bodiments. Furthermore, the operation reception unit may include a unit capable of receiving not only a switching operation for switching between the autonomous movement mode and the manual operation mode using a mode switching button 900 or the like, but may also include a unit capable of receiving an operation for performing predetermined control of the moving body 10.

### Modifications

### First Modification

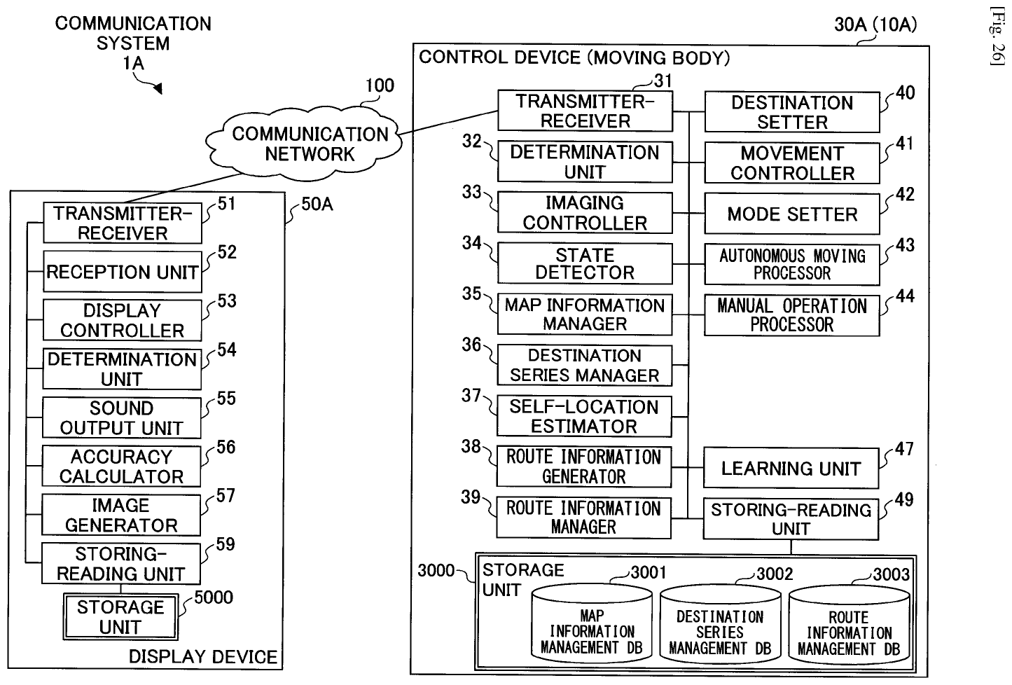

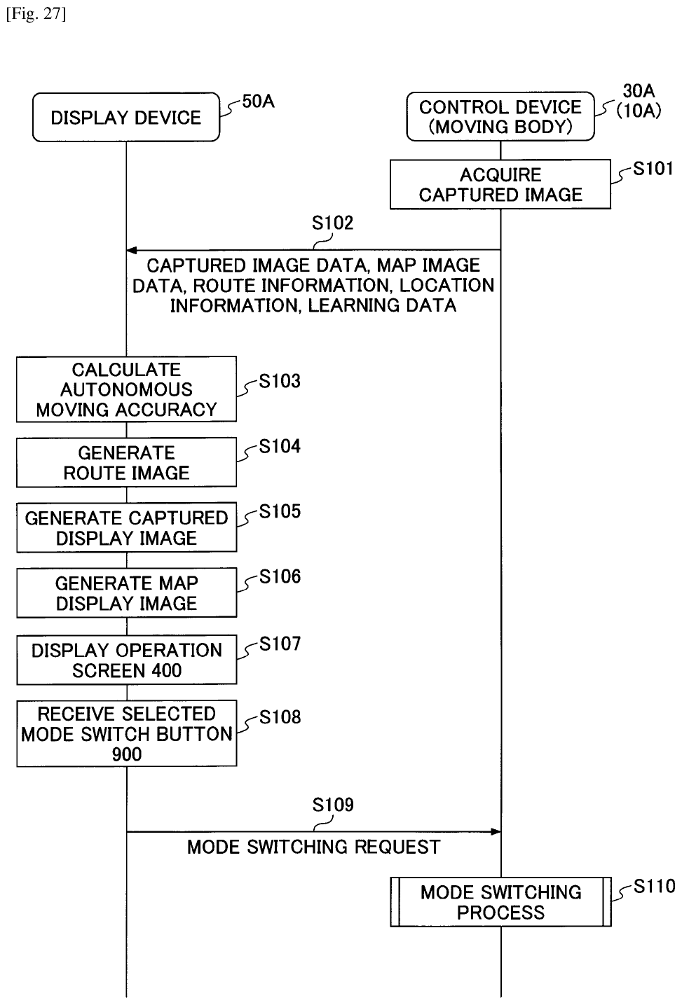

Next, a first modification of the communication system according to the embodiment will be described with reference to FIGS. 26 and 27. The same configuration and functions as in the above embodiments are provided with the same reference numerals and the duplicated descriptions are omitted. A communication system 1A according to the first modification is an example in which the display device 50A calculates the autonomous movement accuracy of the moving body 10A and generates various display images to be displayed on the operation screen 400 or the like.

FIG. 26 is a diagram illustrating an example of a functional configuration of a communication system according to the first modification of the embodiment. The display device 50A according to the first modification illustrated in FIG. 26 includes an accuracy calculator 56 and an image generator 57 in addition to the configuration of the display device 50 illustrated in FIG. 5.

The accuracy calculator 56 is implemented mainly by a process of the CPU 501, and calculates the accuracy of the autonomous movement of the moving body 10A. The image generator 57 is mainly implemented by a process of the CPU 501 and generates a display image to be displayed on the display device 50A. The accuracy calculator 56 and the image generator 57 have the same configurations as the accuracy calculator 45 and the image generator 46, respectively, illustrated in FIG. 5. Accordingly, the control device 30A configured to control the process or operation of the moving body 10A according to the first modification is configured without having functions of the accuracy calculator 45 and the image generator 46.

FIG. 27 is a sequence diagram illustrating an example of an autonomous movement of a moving body and a switching process of a manual operation using an operation screen according to the first modification of the embodiment. FIG. 27 illustrates an example where the moving body 10A has started autonomous movement within the location by the process illustrated in FIG. 10, as in FIG. 12.

First, in step S101, the imaging controller 33 of the control device 30A disposed in the moving body 10A performs imaging process using the imaging device 12 while moving within the location. In step S102, the transmitter-receiver 31 transmits, to the display device 50A, the captured image data captured in step S101, the map image data read in step S12, the route information stored in the route information management DB 3003, location information representing the current position (self-location) of the moving body 10A estimated by the self-location estimator 37, and learned data by the learning unit 47. Accordingly, the transmitter-receiver 51 of the display device 50A receives various data and information transmitted from the moving body 10A.

Next, in step S103, the accuracy calculator 56 of the display device 50A calculates the autonomous movement accuracy of the moving body 10A. The accuracy calculator 45 calculates the autonomous movement accuracy based on the route information and location information received in step S102, for example. The accuracy calculator 56 may calculate the autonomous movement accuracy based on, for example, the learned data and location information received in step S102.

Next, in step S104, the image generator 57 generates a route image that is displayed on the captured image received in step S102. The route image is generated, for example, based on the location information received in step S102, and the location information and status for each destination series illustrated in the route information received in step S102. In step S105, the image generator 57 generates the captured display image in which the route image generated in step S104 is rendered on the captured image received in step S102. In step S106, the image generator 57 generates a map display image in which a current position display image representing the current position (self-location) of the moving body 10A represented by the location information received in step S102 and a series image representing the destination series represented by the route information received in step S102 are rendered on the map image received in step S102.

The details of the process of steps S103, S104, S105, and S106 are similar to those of the process of steps S31, S33, S34, and S35, illustrated in FIG. 12. The order of the process of steps S103 to S106 may be reversed or may be performed in parallel. The display device 50A receives the captured image data transmitted from the moving body 10A at any time through the process of step S102 and continuously performs the process of steps S103 to S106.

Next, in step S107, the display controller 53 displays the operation screen 400 illustrated in FIG. 13 or the like on a display unit such as the display 106. The display controller 53 displays information calculated or generated in the process of step S103 to step S106 on the operation screen 400. The display controller 53 is not limited to the operation screen 400 but may be configured to display any of the above-described operation screens 400A to 400F. Since the subsequent process of step S108 through step S110 is the same as the process of step S38 through step S40 illustrated in FIG. 12, the description thereof will not be repeated.

As described above, in the communication system 1A according to the first modi-fication, even when the autonomous movement accuracy is calculated and various display screens are generated on the display device 50A, the operation screen 400 including the notification information representing the autonomous movement accuracy can be displayed on the display device 50A, so that the operator can easily determine the switching between the autonomous movement and the manual operation.

Second Modification

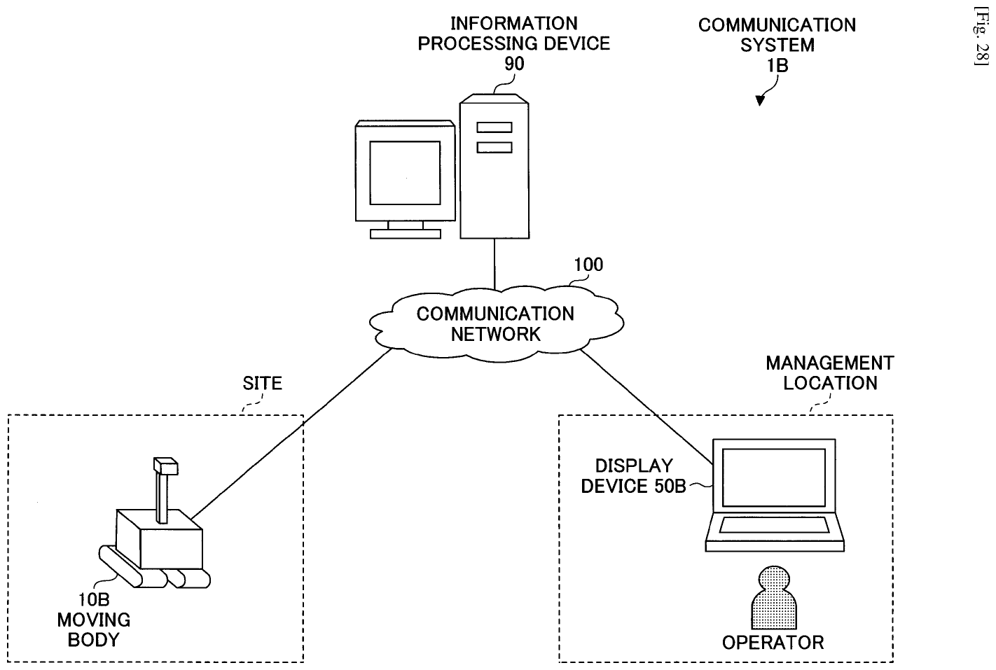

Next, a second modification of the communication system according to the embodiment will be described with reference to FIGS. 28 to 31. The same configuration and functions as in the above embodiments are provided with the same reference numerals and the duplicated descriptions are omitted. A communication system 1B according to the second modification is an example in which an information processing device 90 performs the calculation of the autonomous movement accuracy of a moving body 10B and the generation of various display images to be displayed on the operation screen 400.

FIG. 28 is a diagram illustrating an example of the overall configuration of a communication system according to the second modification of the embodiment. The communication system 1B according to the second modification includes, in addition to the above-described configuration of the embodiment, an information processing device 90 capable of communicating with the moving body 10B and a display device 50B through the communication network 100.

The information processing device 90 is a server computer for managing communication between the moving body 10B and the display device 50B, controlling various types of the moving body 10B, and generating various display screens to be displayed on the display device 50B. The information processing device 90 may be configured by one server computer or a plurality of server computers. The information processing device 90 is described as a server computer present in the cloud environment, but may be a server present in the on-premise environment. Herein, the hardware configuration of the information processing device 90 has the same configuration as the display device 50 as illustrated in FIG. 4. Hereinafter, for the sake of convenience, the hardware configuration of the information processing device 90 will be described using reference numerals in the 900s for the configuration illustrated in FIG. 4.

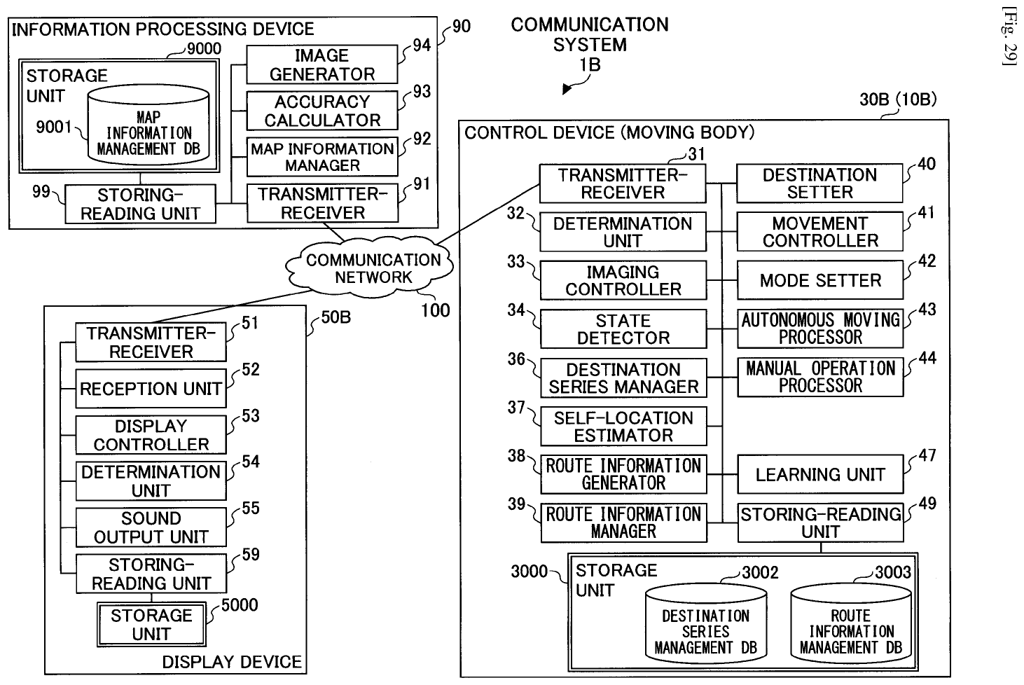

FIG. 29 is a diagram illustrating an example of a functional configuration of a communication system according to a second modification of the embodiment. The configuration of the display device 50B according to the second modification illustrated in FIG. 29 is similar to the configuration of the display device 50 illustrated in FIG. 5. Further, the control device 30B configured to control the process or operation of the moving body 10B according to the second modification does not include the functions of the map information manager 35, the accuracy calculator 45, and the image generator 46, and the configuration of the map information management DB 3001 constructed in the storage unit 3000.

The information processing device 90 includes a transmitter-receiver 91, a map information manager 92, an accuracy calculator 93, an image generator 94, and a storing-reading unit 99. Each of these units is a function or a functional unit that can be implemented by operating any of the components illustrated in FIG. 4 according to an instruction from the CPU 901 according to a program for an information processing device loaded on a RAM 903. The information processing device 90 includes a storage unit 9000 that is constructed by the ROM 902, the HD 904, or the recording medium 921 illustrated in FIG. 4.

The transmitter-receiver 91 is implemented mainly by a process of the CPU 901 with respect to the network I/F 908, and is configured to transmit and receive various data or information from and to other devices or terminals.

The map information manager 92 is mainly implemented by a process of the CPU 901, and is configured to manage map information representing an environmental map of a target location where the moving body 10B is installed, using the map information management DB 9001. For example, the map information manager 92 manages an environmental map downloaded from an external server or the like or map information representing the environmental map created by applying SLAM.

The accuracy calculator 93 is implemented mainly by a process of the CPU 901, and is configured to calculate the accuracy of the autonomous movement of the moving body 10B. The image generator 94 is mainly implemented by a process of the CPU 301 and generates a display image to be displayed on the display device 50B. The accuracy calculator 93 and the image generator 94 have the same configurations as the accuracy calculator 45 and the image generator 46, respectively, illustrated in FIG. 5.

The storing-reading unit 99 is implemented mainly by a process of the CPU 901, and is configured to store various data (or information) in the storage unit 9000 or reads various data (or information) from the storage unit 9000. A map information management DB 9001 is constructed in the storage unit 9000. The map information management DB 9001 consists of the map information management table illustrated in FIG. 6.

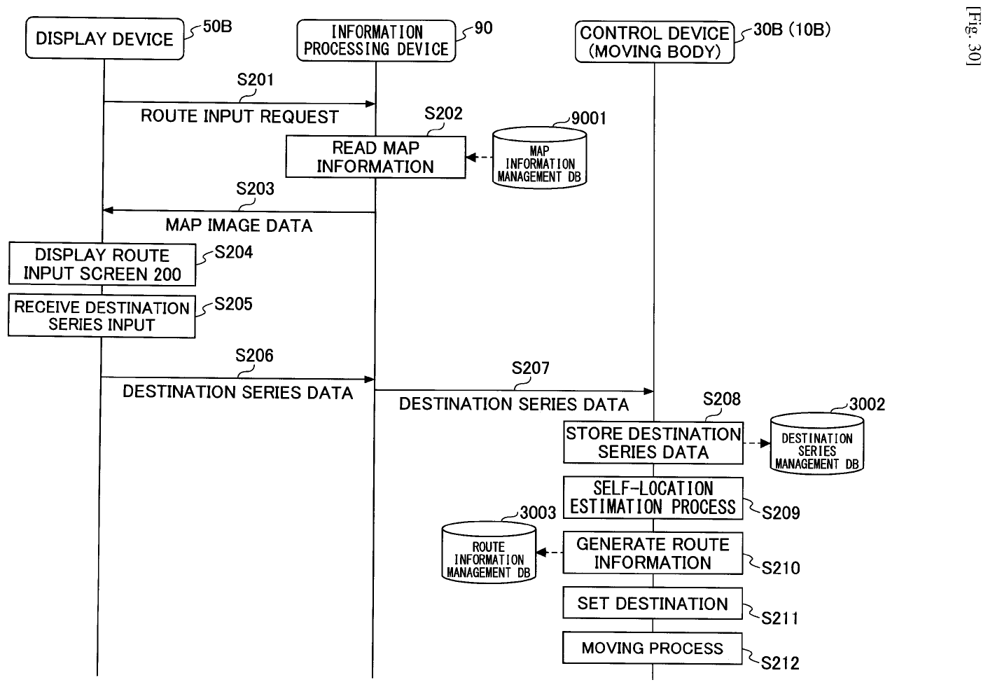

FIG. 30 is a sequence diagram illustrating an example of process up to the start of movement of a moving body according to the second modification of the embodiment. First, in step S201, the transmitter-receiver 51 of the display device 50B transmits a route input request indicating that an input of the moving route of the moving body 10 is requested to the information processing device 90 in response to a predetermined input operation of an operator and the like. The route input request includes a location ID identifying a location where the moving body 10B is located. As a result, the transmitter-receiver 91 of the information processing device 90 receives the route input request transmitted from the display device 50B.

Next, in step S202, the map information manager 92 of the information processing device 90 searches the map information management DB 9001 (see FIG. 6) using the location ID received in step S201 as the retrieval key and reads map information associated with the same location ID as the received location ID through the storing-reading unit 99. The map information manager 92 accesses the stored position illustrated in the read map information and reads a corresponding map image data.

Next, in step S203, the transmitter-receiver 91 transmits the map image data corre-sponding to the map information read in step S202 to the display device 50B that has transmitted the route input request (a request source). Thus, the transmitter-receiver 51 of the display device 50B receives the map image data transmitted from the information processing device 90.

Next, in step S204, the display controller 53 of the display device 50B displays the route input screen 200 (see FIG. 11) including the map image data received in step S203 on the display unit, such as the display device 506. Then, in step S205, the operator selects a predetermined position on the map image and clicks the “Complete” button 210, so that the reception unit 52 receives an input from the destination series 250a to 250h, as in step S15 of FIG. 12. In step S206, the transmitter-receiver 51 transmits destination series data representing the destination series 250a to 250h received in step S205 to the information processing device 90. The destination series data includes location information representing positions on the map image of the destination series 250a to 250h inputted in step S205. In step S207, the transmitter-receiver 91 of the information processing device 90 transmits (transfers) the destination series data transmitted from the display device 50B to the moving body 10B. Accordingly, the transmitter-receiver 31 of the control device 30B disposed in the moving body 10B receives the destination series data transmitted from the display device 50B. Since the subsequent process of step S208 through step S212 is the same as the process of step S17 through step S21 illustrated in FIG. 10, the description thereof will not be repeated.

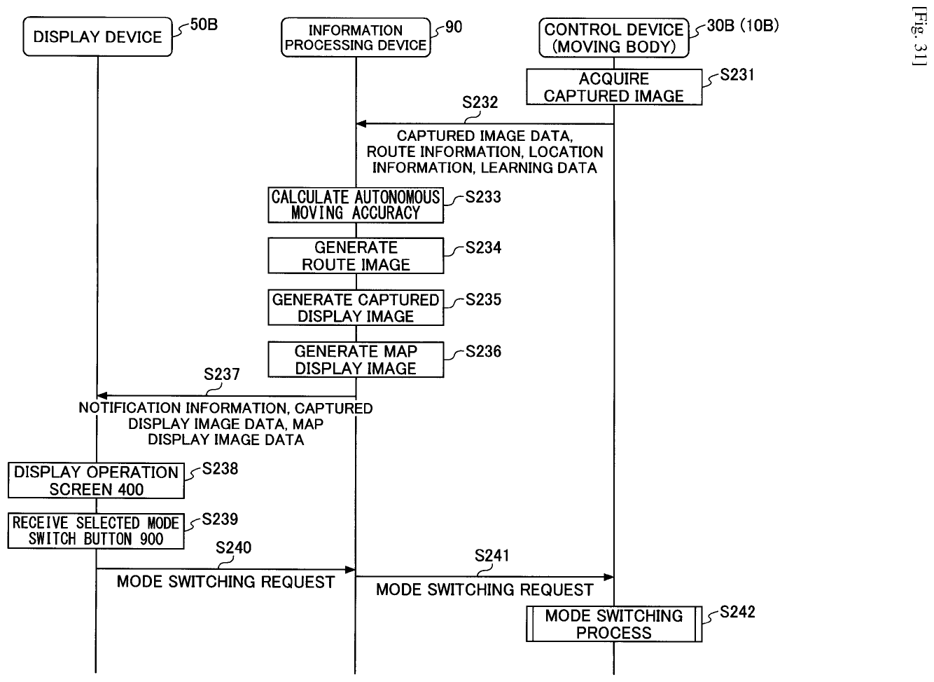

FIG. 31 is a sequence diagram illustrating an example of an autonomous movement of a moving body and a switching process of a manual operation using an operation screen according to the second modification of the embodiment. FIG. 31 illustrates an example where the moving body 10B starts autonomous movement within the location by the process illustrated in FIG. 10, as in the process of FIG. 12.

First, in step S231, the imaging controller 33 of the control device 30B disposed in the moving body 10B performs imaging process using the imaging device 12 while moving within the location. In step S232, the transmitter-receiver 31 transmits to the information processing device 90 captured image data acquired in step S231, route information stored in the route information management DB 3003, location information representing the current position (self-location) of the moving body 10B estimated by the self-location estimator 37, and learned data acquired by the learning unit 47. Ac-cordingly, the transmitter-receiver 91 of the information processing device 90 receives various data and information transmitted from the moving body 10B.

Next, in step S233, the accuracy calculator 93 of the information processing device 90 calculates the autonomous movement accuracy of the moving body 10B. The accuracy calculator 45 calculates the autonomous movement accuracy based on the route information and the location information received in step S232, for example. The accuracy calculator 56 may calculate the autonomous movement accuracy based on, for example, the learned data and location information received in step S232.

Next, in step S234, the image generator 94 generates a route image that is displayed on the captured image received in step S232. The route image is generated, for example, based on location information received in step S232, and location information and status for each destination series illustrated in the route information received in step S232. In step S235, the image generator 57 generates the captured display image in which the route image generated in step S234 is rendered on the captured image received in step S232. In step S236, the image generator 94 generates a map display image in which a current position display image representing the current position (self-location) of the moving body 10B indicated in the location information received in step S232 and a series image representing the destination series indicated in the route information received in step S232 are rendered on the map image read in step S202.

The details of the process of steps S233, S234, S235, and S236 are similar to the process of steps S31, S33, S34, and S35, respectively, illustrated in FIG. 12. The order of the processes of steps S233 to S236 may be reversed or may be performed in parallel. The information processing device 90 receives the captured image data transmitted from the moving body 10 at any time through the process in step S232 and continuously performs the process in steps S233 to S236.

Next, in step S237, the transmitter-receiver 91 transmits, to the display device 50B, notification information representing the autonomous movement accuracy calculated in step S233, the captured display image data generated in step S235, and the map display image data generated in step S236. Thus, the transmitter-receiver 51 of the display device 50B receives the notification information, the captured display image data, and the map display image data transmitted from the information processing device 90.

Next, in step S238, the display controller 53 of the display device 50B displays the operation screen 400 illustrated in FIG. 13 or the like, on a display unit such as the display 106. The display controller 53 displays the data and information received in step S237 on the operation screen 400. The display controller 53 is not limited to displaying the operation screen 400, but may display any of the above-described operation screens 400A to 400F.

Next, in step S239, as in step S38 of FIG. 12, in response to an input operation using an input unit such as an operator's pointing device 512, the reception unit 52 receives the selection of the mode switching button 900 on the operation screen 400. In step S240, the transmitter-receiver 51 transmits, to the information processing device 90, a mode switching request indicating that the switching between the autonomous movement mode and the manual operation mode of the moving body 10B is requested. In step S241, the transmitter-receiver 91 of the information processing device 90 transmits (transfers) the mode switching request transmitted from the display device 50B to the moving body 10B. Accordingly, the transmitter-receiver 31 of the control device 30B disposed in the moving body 10B receives the mode switching request transmitted from the display device 50B. In step S242, the control device 30B performs the mode switching process of the moving body 10B illustrated in FIG. 16 in response to the mode switching request received in step S241.

As described above, in the communication system 1B according to the second modi-fication, the operation screen 400 including the notification information representing the autonomous movement accuracy can be displayed on the display device 50B even when the autonomous movement accuracy is calculated and various display screens are generated in the information processing device 90. This enables the operator to easily determine switching between the autonomous movement and the manual operation.

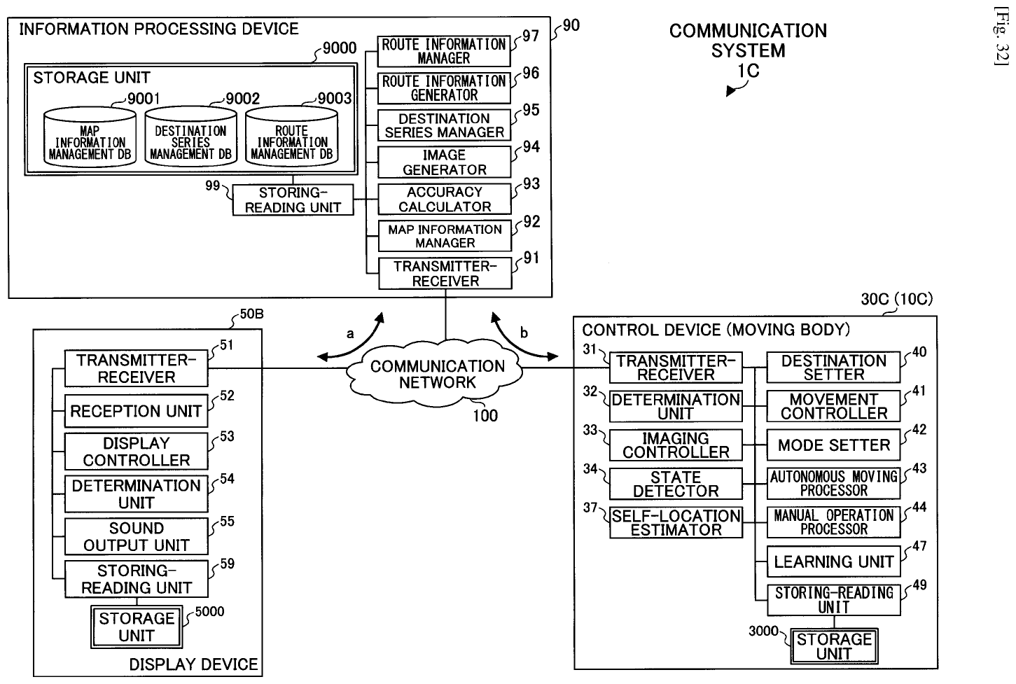

FIG. 32 is a diagram illustrating an example of a functional configuration of a communication system. In comparison with the functional configuration of the communication system illustrated in FIG. 29, the display device 50 is similar to the configuration of the display device 50 illustrated in FIG. 29. A control device 30C configured to control the process or operation of a moving body 10C has a configuration that excludes, from the control device 30B illustrated in FIG. 29, the destination series manager 36, the route information generator 38, and the route information manager 39, as well as excluding the destination series management DB 3002 and the route information management DB 3003 constructed in the storage unit 3000 illustrated in FIG. 29.

In the communication system 1C illustrated in FIG. 32, the information processing device 90 corresponds to a cloud computing service such as, for example, AWS (trademark), and the communication system 1C communicates the display device 50 and the moving body 10C (control device 30C) through the information processing device 90 as indicated by arrows a and b. The functions of the destination series manager 36, the route information generator 38, the route information manager 39, the destination series management DB 3002, and the route information management DB 3003 that are excluded from the control device 30B are transferred to the information processing device 90. That is, the information processing device 90 includes the transmitter-receiver 91, the map information manager 92, the accuracy calculator 93, the image generator 94, the destination series manager 95, the route information generator 96, and the route information manager 97. Further, the map information management DB 9001, the destination series management DB 9002, and the route information management DB 9003 are constructed in the storage unit 9000 of the information processing device 90. The functions of the above-described units transferred from the control device 30B (FIG. 29) to the information processing device 90 are the same as the functions described in FIG. 29 and the like. Thus, the description thereof is omitted.

As described above, in the communication system 1C, communication between the display device 50 and the moving body 10C (the control device 30C) is performed through the information processing device 90 corresponding to the cloud computing service. In the information processing device 90, authentication process by the cloud computing service can be used at the time of communication, so that the security of the manual operation command from the display device 50, the captured image data from the moving body 10C, and the like can be improved. In addition, placing each data generation function and management function in the information processing device 90 (cloud service) enables sharing of the same data at multiple locations, so that not only P2P (peer-to-peer) communication (one-to-one direct communication) but also one-to-many-location communication can be flexibly handled.

Summary 1

As described above, a display system according to embodiments of the present invention is a display system that performs a predetermined operation with respect to a moving body 10 (10A, 10B, and 10C). The display system includes an operation reception unit (an example of a mode switching button 900) configured to receive a switching operation for switching between a manual operation mode in which the moving body 10 (10A, 10B, and 10C) is moved manually and an autonomous movement mode in which the moving body 10 (10A, 10B, and 10C) is moved by autonomous movement; and a display controller 53 (an example of a display controller) configured to display notification information representing accuracy of the autonomous movement. With the configuration described above, the display system according to the embodiments of the present invention enables a user to easily determine whether to switch between the autonomous movement and the manual operation, thereby improving operability when the user switches between the autonomous movement and the manual operation.

Further, in the display system according to the embodiments of the present invention, when a switching operation for switching between the manual operation mode and the autonomous movement mode is received, a switching request for switching between the autonomous movement mode and the manual operation mode is transmitted to the moving body 10 (10A, 10B, and 10C), and switching between the autonomous movement mode and manual operation mode of the moving body 10 (10A, 10B, and 10C) is performed based on the transmitted switching request. As a result, the display system according to the embodiments of the present invention is enabled to control the switching between the autonomous movement and the manual operation of the moving body 10 (10A, 10B, and 10C) in response to the user's request.

Further, in the display system according to the embodiments of the present invention, notification information representing the accuracy of autonomous movement is information indicating learning accuracy of the autonomous movement, which enables the moving body 10 (10A, 10B, and 10C) to learn for the autonomous movement when the moving body 10 (10A, 10B, 10C) is switched from the autonomous movement mode to the manual operation mode. As a result, the display system according to the embodiment of the invention enables the operator to more appropriately determine the necessity of learning by manual operation.

The communication according to the embodiments of the present invention is the communication system 1 (1A, 1B, and 1C) that includes a display system for performing a predetermined operation with respect to a moving body 10 (10A, 10B, and 10C); and the moving body 10 (10A, 10B, and 10C). In the communication system, the moving body 10 (10A, 10B, and 10C) receives a switching request between an autonomous movement mode and a manual operation mode transmitted from the display system 1 (1A, 1B, and 1C), sets a desired one of the autonomous movement mode and the manual operation mode, based on the received switching request, and performs a moving process of the moving body 10 (10A, 10B, and 10C), based on the set desired mode. As a result, in the communication system 1 (1A, 1B, and 1C), the moving body 10 (10A, 10B, and 10C) switches between the autonomous movement mode and the manual operation mode, in response to the switching request transmitted from the display system, such that the movement control of the moving body 10 (10A, 10B, and 10C) can be performed in response to the user's request.

Further, according to the embodiments of the present invention, the moving body 10 (10A, 10B, and 10C) learns the moving route for the autonomous movement when the manual operation mode is set, and calculates the accuracy of the autonomous movement based on the learned data. When the autonomous movement mode is set, the moving body 10 (10A, 10B, and 10C) moves autonomously based on the learned data. Accordingly, the communication system 1 (1A, 1B, and 1C) can perform autonomous movement of the moving body 10 (10A, 10B, and 10C) using the learned data and can improve the accuracy of autonomous movement of the moving body 10 (10A, 10B, and 10C) by learning about autonomous movement using various types of data acquired in the manual operation mode of the moving body 10 (10A, 10B, and 10C).

Summary 2

As described above, a display system according to embodiments of the present invention is a display system for displaying an image of a predetermined location captured by a moving body 10 (10A and 10B), which moves within the predetermined location. The display system receives the captured image transmitted from the moving body 10 (10A and 10B), and superimposes virtual route images 711, 713, and 715 on a moving route of the moving body 10 (10A and 10B) in the predetermined location rep-resented in the received captured image. As a result, the display system according to the embodiments of the present invention enables a user or an operator to properly identify a moving state of the moving body 10 (10A and 10B).

Further, the display system according to the embodiments of the present invention, the virtual route images 711, 713, and 715 include images representing a plurality of points on the moving route, an image representing a moving history of the moving body 10 (10A and 10B), and an image representing a future destination of the moving body 10 (10A and 10B). Accordingly, the display system according to the em-bodiments of the invention displays on an operation screen 400 or the like used by an operator a captured display image, which is formed by presenting the virtual route images 711, 713, and 715 on the moving route of the moving body 10 (10A and 10B) represented in the captured image.

Further, the display system according to the embodiments of the present invention receives an input of route information representing a moving route of the moving body 10 (10A and 10B), transmits the received input route information to the moving body 10 (10A and 10B), and moves the moving body 10 (10A and 10B) based on the transmitted route information. The display system receives the input route information on a map image representing a location, superimposes series images 611, 613, and 615 representing the route information on the map image, displays the map image together with a captured image on which the virtual route images 711, 713, and 715 are su-perimposed. Accordingly, the display system according to the embodiments of the present invention enables an operator to visually identify the moving state of the moving body 10 (10A and 10B) by displaying a map display image, in which the series images 611, 613, and 615 representing the route information are presented on the map image, together with a captured display image. Thus, the operability of the moving body 10 by the operator can be improved.

The display system according to the embodiments of the present invention further includes an operation reception unit that receives an operation for providing predetermined control over the moving body 10 (10A and 10B). The operation reception unit is a mode switching button 900 which receives a switching operation to switch between a manual operation mode in which the moving body 10 (10A and 10B) is moved by manual operation and an autonomous movement mode in which the moving body 10 (10A and 10B) is moved autonomously. Accordingly, the display system according to the embodiments of the present invention can improve operability of an operator to switch between the autonomous movement and the manual operation by using the mode switching button 900 when the operator switches between the autonomous movement and the manual operation.

Further, in the display system according to the embodiments of the present invention, an autonomous movement is a learning-based autonomous movement, and when the moving body 10 (10A and 10B) is switched from the autonomous mode to the manual mode of operation, the moving body 10 (10A and 10B) is enabled to perform learning for autonomous movement. The learning for autonomous movement is performed using the captured image acquired by the moving body 10 (10A and 10B). Ac-cordingly, the display system according to the embodiments of the present invention can perform autonomous movement of the moving body 10 (10A and 10B) using the learned data, and improve the autonomous movement accuracy of the moving body 10 (10A and 10B) by performing learning for autonomous movement using the captured image.

A communication system according to an embodiment of the present invention is a communication system 1 (1A and 1B) that includes a display system for displaying an image captured by a moving body 10 (10A and 10B) moving within a predetermined location, and the moving body 10 (10A and 10B). The communication system 1 (1A and 1B) generates a display image in which virtual route images 711, 713, and 715 are superimposed on the captured image, based on location information representing the current position of the moving body 10 (10A and 10B) and route information representing the moving route of the moving body 10 (10A and 10B). Accordingly, the communication system 1 (1A and 1B) generates and displays a captured display image that visually indicates the moving route of the moving body 10, thereby enabling an operator to properly identify the moving state of the moving body 10 (10A and 10B).

In the communication system according to the embodiments of the present invention, the moving body 10 (10A and 10B) receives a switching request for switching between an autonomous movement mode and a manual operation mode transmitted from the display system, sets either an autonomous movement mode or a manual operation mode based on the received switching request, and performs the moving process of the moving body 10 (10A and 10B) based on the set mode. Accordingly, in the communication system 1 (1A and 1B), the moving body 10 (10A and 10B) switches an operation mode between the autonomous movement mode and the manual operation mode in response to the switching request transmitted from the display system. This enables a user to perform of the movement control of the moving body 10 (10A and 10B) according to the user's request.

Supplementary Information

The functions of the embodiments described above may be implemented by one or more process circuits. Herein, in the present embodiments, “process circuits” include processors programmed to perform each function by software, such as processors implemented by electronic circuits, and devices such as ASIC (Application Specific In-tegrated Circuit), DSP (digital signal processor), FPGA (field programmable gate array), SOC (System on a chip), GPU (Graphics Processing Unit), and conventional circuit modules designed to perform each function as described above.

Various tables of the embodiments described above may also be generated by the learning effect of the machine learning, and the associated data of each item may be classified by the machine learning without the use of a table. Herein, machine learning is a technology that enables computers to acquire human-like learning capabilities, which refers to a technology that enables computers to autonomously generate algorithms necessary for making decisions, such as data identification, from learning data that is imported in advance, and then apply these algorithms to new data to make predictions. Learning methods for machine learning can be any of supervised, unsu-pervised, semi-supervised, reinforcement, and deep learning methods, as well as a combination of these learning methods.

While the display system, the communication system, the display control method, and the program have been described in accordance with the embodiments of the present invention, the invention is not limited to the embodiments described above, but may be modified to the extent conceived by one skilled in the art, such as adding, modifying or deleting other embodiments, and any aspect of the embodiments may fall within the scope of the invention so long as the invention is effective.

### REFERENCE SIGNS LIST

1, 1A, 1B, 1C communication system
100 communication network
10, 10A, 10B, 10C moving body
30, 30A, 30B, 30C control device
31 transmitter-receiver (an example of a switching request receiver and an example
of an accuracy transmitter)
37 self-location estimator (an example of a self-location estimator)
38 route information generator (an example of a route information generator)
42 mode setter (an example of a mode setter)
43 autonomous moving processor (an example of a moving processor)
44 manual operation processor (an example of a moving processor)
45 accuracy calculator (an example of a second accuracy calculator)
46 image generator
47 learning unit (an example of a learning unit)
50, 50A, 50B display device
51 transmitter-receiver (an example of a switching request transmitter, an example of an acquisition unit)
52 reception unit
53 display controller (an example of display controller)
56 accuracy calculator (an example of a first accuracy calculator)
57 image generator (an example of an acquisition unit)
90 information processing device
91 transmitter-receiver
93 accuracy calculator
94 image generator
200 route input screen
250 destination series
400, 400A, 400B, 400C, 400D, 400E, 400F operation screen
600 map display image area
611, 613, 615 series image
650, 660 accuracy display image
700 captured display image area
711, 713, 715 route image
750, 760 accuracy display image
800 notification information display area
900 mode switching button (an example of operation reception unit)

The present application is based on and claims the benefit of priorities of Japanese Priority Application No. 2021-047517 filed on Mar. 22, 2021, Japanese Priority Application No. 2021-047582 filed on Mar. 22, 2021, and Japanese Priority Application No. 2022-021463 filed on Feb. 15, 2022, the contents of which are incorporated herein by reference.

1-35. (canceled)

36. A display system for performing a predetermined operation with respect to a moving body, the display system comprising:
operation reception circuitry configured to receive a switching operation to switch an operation mode between a manual operation mode and an autonomous movement mode, the manual operation mode being selected for moving the moving body by manual operation and the autonomous movement mode being selected for moving the moving body by autonomous movement;
display control circuitry configured to display a location display image representing a moving route of the moving body, and notification information representing accuracy of the autonomous movement according to a position on the moving route; and
switching request transmitter configured to transmit a switching request for switching the operation mode between the autonomous movement mode and the manual operation mode to the moving body, in response to receiving of the switching operation,
wherein the switching of the operation mode between the autonomous movement mode and the manual operation mode of the moving body is performed based on the transmitted switching request.

37. The display system according to claim 36, wherein:
the autonomous movement is a learning-based autonomous movement.

38. The display system according to claim 37, wherein:
the notification information is information indicating learning accuracy of the autonomous movement.

39. The display system according to claim 37, wherein:
the moving body is enabled to perform learning for the autonomous movement, in response to the moving body being switched from the autonomous movement mode to the manual operation mode.

40. The display system according to claim 36, further comprising:
first accuracy calculation circuitry configured to calculate the accuracy of the autonomous movement, based on location information and route information, the location information representing a current position of the moving body moving within the location and the route information representing the moving route of the moving body, wherein
the display control circuitry displays the accuracy of the autonomous movement calculated by the first accuracy calculator as the notification information, and changes the notification information according to the current position of the moving body.

41. The display system according to claim 40, wherein:
the first accuracy calculation circuitry calculates the accuracy of the autonomous movement, based on the location information, the route information, and learned data that is associated with the autonomous movement of the moving body.

42. The display system according to claim 36, wherein:
the display control circuitry displays a numerical value representing the accuracy of the autonomous movement as the notification information.

43. The display system according to claim 36, wherein:
the display control circuitry displays an image representing the accuracy of the autonomous movement as the notification information.

44. The display system according to claim 43, further comprising:
acquiring circuitry configured to acquire the location display image representing the moving route of the moving body in an image representing the location,
wherein the display control circuitry displays the image representing the accuracy of the autonomous movement on the acquired location display image as the notification information.

45. A communication system comprising:
the display system according to claim 36; and
the moving body, including:
a switching request receiver configured to receive the switching request transmitted from the display system,
mode setting circuitry configured to set a desired one of the autonomous movement mode and the manual operation mode, based on the received switching request, and
moving processing circuitry configured to perform a moving process of the moving body based on the set desired mode.

46. The communication system according to claim 45, wherein the moving body further includes:
self-location estimation circuitry configured to estimate a current position of the moving body;
route information generation circuitry configured to generate route information representing the moving route of the moving body;
second accuracy calculation circuitry configured to calculate the accuracy of autonomous movement, based on location information representing the estimated current position and the generated route information; and
an accuracy transmitter to transmit the notification information representing the calculated accuracy of the autonomous movement to the display system,
wherein the display control circuitry of the display system displays the notification information transmitted from the moving body.

47. The communication system according to claim 46, wherein the moving body further comprises:
learning circuitry configured to perform learning of the moving route associated with the autonomous movement in response to the manual operation mode being set by the mode setting circuitry,
wherein the second accuracy calculator calculates the accuracy of the autonomous movement, based on learned data acquired by the learning of the learning circuiry.

48. The communication system according to claim 47, wherein the moving processor moves the moving body by autonomous movement, based on the learned data acquired by the learning of the learning circuitry, in response to the autonomous movement mode being set by the mode setting circuitry.

49. A display control method, comprising:
receiving a switching operation to switch an operation mode between a manual operation mode and an autonomous movement mode, the manual operation mode being selected for moving a moving body by manual operation and the autonomous movement mode being selected for moving the moving body by autonomous movement; and
displaying notification information representing accuracy of the autonomous movement.
